(19) United States
(12) Patent Application Publication
(10) Pub. No.: US 2006/0218031 A1
(43) Pub. Date: Sep. 28, 2006

(54) System and methodology for collecting autobiographical data concerning use of consumer products or exposures to substances

(75) Inventors: Myron S. Weinberg, Potomac, MD (US); Wil Dijkstra, The Netherlands (NL); Robert F. Belli, Lincoln, NE (US); Mukhtar Ahmed, High Wycombe (GB)

Correspondence Address: ROTHWELL, FIGG, ERNST & MANBECK, P.C., 1425 K STREET, N.W., SUITE 800, WASHINGTON, DC, 20005, US

(73) Assignee: The Weinberg Group LLC, Brussels (BE)

(21) Appl. No.: 11/089,032

(22) Filed: Mar. 25, 2005

(51) Int. Cl. G07G 1/00

(52) U.S. Cl. 705/10

(57) ABSTRACT

A system and method for implementing a computer-aided event history calendar includes computer component systems for storing, processing, displaying, and entering the event history calendar data. Recall of retrospective, autobiographical use of consumer products or substance exposure is facilitated in the context of an event history calendar whereby a respondent is asked questions concerning the occurrence and timing of various important life events throughout the respondent's life. Questions are asked regarding the respondent's usage of particular consumer products or exposures to substances as well as the sources of those products or substances. To assist the respondent in recalling the specific sources of consumer products or substances, source-identifying features of various possible consumer products the respondent may have used or substances the respondent may have been exposed to are displayed to the user. In one application of the invention intended to assess the likelihood of contracting lung cancer associated with the use of low-tar verses full flavor cigarettes, users are asked about the brand, timing, and amount of cigarettes used throughout their lifetime, and to assist the user's recall, images of various cigarette packaging are displayed to the user.

### FIELD OF THE INVENTION

The present invention relates to the collection of retrospective, autobiographical data, including retrospective information concerning past use of consumer products and/or exposures to particular substances. More specifically, the invention relates to methodologies for facilitating recall of specific past consumer product use.

### BACKGROUND OF INVENTION

Often psychological, social, health, occupational, and epidemiological research requires the gathering of retrospective life history data from study participants. The ability to accurately and reliably gather such information is typically limited by the ability of the respondents to recall past life history events and conditions. Imperfect memory on the part of the respondents is an important source of error that compromises data quality.

One method of collecting data from study respondents is the traditional, question list surveys on social, health, and economic matters. In this methodology, interviewers read questions exactly as written, and respondents are usually constrained to provide short answers. Although question list interviewing techniques are suitable for asking attitude questions of respondents, there are serious concerns about the effectiveness of such techniques in providing quality reports on factual questions, including retrospective, autobiographical data. Challenges created by limitations in respondent memory of retrospective events are especially acute in the context of the question-list interviewing methodology.

A second survey technique for gathering retrospective data is known as the event history calendar (“EHC”) (also known as the life history calendar or “LHC”) interviewing methodology. The purpose of the EHC technique is to collect information from respondents on events and conditions regarding important aspects of the respondent's life (e.g., residence, marriage, occupation, health, etc.) during their entire lifetimes. The aspects of life that are included in the EHC are called “domains.” The EHC methodology helps respondents remember events and changes in their lives and when these events actually occurred. The technique also helps the interviewer spot potential inconsistencies or problems in the dating of events or changes so they can ask respondents to clarify or correct these problems.

During an EHC interview, the responses supplied with respect to various domains (e.g., groupings of related events and/or conditions, e.g., residences, occupations, education, etc.) can provide cues with respect to questions within the same domain and across other domains. EHCs are designed to use cues that are available in the memory of respondents. There are several ways in which events are stored and linked in the memories of respondents, and thus several ways in which respondents recall and offer reports on those events. Various cuing techniques have been developed to describe and survey the different memory pathways that relate events to one another. In particular, three different cuing techniques have been identified and are exploited in the EHC methodology (Belli, 1998). A first cuing type is known as top-down cuing and refers to relationships that persist from the top to the bottom of a hierarchy. In the memory process, lifetime periods index general events, and general events in turn index more specific events. For example, a job with a particular employer indexes such job terms as position title and one's work duties. A second cuing type is sequential cuing which refers to the chronological sequencing of events within the same domain. Events are organized in memory of what happened earlier versus later in time. Often, such sequential cuing is based on the logical constraints of the social environment, such as the fact that one has a position change or job promotion after one starts a job. At other times, events are sequenced as people remember past events when encountering contemporary ones, such as remembering one's past employment situations during recall and report on one's present job. A third cuing type is parallel cuing which refers to associations that exist across domains. This memory process reflects the fact that many aspects of life infringe upon individuals simultaneously or nearly so. For example, a change in employment may effect the residential situations and perhaps other aspects of the respondent's life.

An EHC interview is designed to be less structured than a question list interview where all questions must be read exactly as written and only in the order specified in the questionnaire. In contrast, to the highly structured question list approach, EHC offers flexibility in the ways and order in which an interviewer covers each domain and asks specific questions.

EHC serves both as a memory aid for the respondent and as a way to record information offered by the respondent. There are several ways in which EHC is useful as a memory aid. EHC begins by taking advantage of the fact respondent's are likely to remember some types of events more clearly than others. The EHC does this by starting out with events that people are most likely to remember. Once these events are recorded it is easier to determine the events respondents are less likely to remember. For example, almost everyone remembers the year when they moved into a new house, or the year in which they got married. The EHC is designed to use these years to help a respondent remember other, less memorable, events.

Data gathered during an EHC questionnaire is typically recorded in the form of timelines in which at least one timeline is preferably dedicated to each domain (e.g., residence, occupation, marriage status, health, etc.) or a specific aspect of a domain, and a particular response is positioned accordingly on the timeline so as to reflect the time range to which the answer corresponds. For example, if a respondent was employed as a plumber for the Acme Plumbing Company from 1991 through 1997, a timeline reflecting the occupations of the respondent throughout his/her working life would include, as part of that timeline from 1991-1997, that the respondent was employed as a plumber for the Acme Plumbing Company.

As the EHC timelines are filled out, they provide visual cues respondents can use to help them recall the timing of particular life events and can also help the interviewer structure questions and probes. Cross-referencing such timelines can be useful for spotting inconsistencies and errors in recalled information. For example, if the respondent reported moving from Buffalo, N.Y. to Detroit, Mich. in 1988 but later reported that he began working for the Ford Motor Company in Detroit in 1985 that inconsistency could indicate an error in one or both responses. EHC provides interviewer flexibility whereby interviewers, upon noting such inconsistencies, can follow up with further clarifying questions in an attempt to resolve the inconsistency.

One potential difficulty of the more flexible EHC approach, however, is that questions may be missed by interviewers, or asked by different interviewers in widely divergent ways, thereby jeopardizing comparability on key variables. Also, information may be entered by the interviewer in the wrong place on the calendar or entered in a fashion that can't be interpreted by data entry, editing, and coding staff. Thus, the EHC cannot be totally unstructured, and must, to some extent, employ standardized scripts, probes, and data recording conventions.

The EHC methodology began as a paper and pencil technique whereby interviewee responses were transcribed by hand into vertically or horizontal arranged timelines printed on paper. Paper and pencil techniques are cumbersome in that the time required to transcribe responses can interrupt the flow of the interview. Moreover, interviewers often vary in their abilities to recognize and follow up on various cues for probing for information between parallel domains, and such variances are particularly notable in paper and pencil administration of the EHC. (Belli, 2000).

To overcome some of these disadvantages and provide an amount of structure to the EHC interview, Computer Assisted Interviewing—Event History Calendar (“CAI-EHC”) techniques have been developed (Belli, 2000). In such methodologies, through programmed software applications, data files can be created or updated at the same time the data is being collected and during an interview. Such automation can ensure the consistency and completeness of collected data, and can assist interviewers to recognize situations in which probes would assist autobiographical recall.

The objective of the EHC methodology is collection of data on the timing and sequencing of personal events and conditions in the lives of individual respondents. EHC methods are designed to facilitate this task by providing a matrix of visual cues respondents can use to help them recall the timing of those events. The timelines prepared during the EHC interview form a matrix of visual cues which provide the substantive domain cues running down a left-hand margin and standardized timing cues (years and ages) running across the top of the calendar. (Axinn, Pearce, and Ghiimire, 1999).

Attempts have been made to enhance the visual cues incorporated into the EHC interview. For example, the collection of occupational history data of migrant workers has been enhanced by using physical icons (e.g., of crops, farm tasks, and non-farm jobs) incorporated into a life event calendar. The icons served as memory aids to help the subjects place a job in time and to recall crops and tasks they might have forgotten. (Zahm, et al., 2001) (Engel, et al., 2001).

EHC data gathering techniques have found application in studies concerning the health effects of particular conditions, habits, and lifestyles. For example, the EHC methodology has been used in a community-based study of low income women to better understand the cumulative effects of domestic violence on their health and financial well-being over time. (Yoshihama, Clum, Crampton, Gillespie, 2002) Other studies have retrospectively analyzed professional careers and mistakes that have occurred and have affected a respondent's career. (Reimer, 2004). Other EHC applications have involved gathering occupational exposure history information from farmers (Hoppin, et al., 1998). The EHC methodology has also been used to ascertain occupational histories and other characteristics of migrant farm workers. (Zahm, et al., 2001) And still other studies have involved an investigation of major life events and monthly patterns of binge drinking, cigarette use, and marijuana use. (Bailey, Hill, Hawkins, and Catalano).

While the adverse health effects of tobacco use, and in particular cigarette smoking, have been widely reported and are well known, many people worldwide continue to smoke cigarettes and use other tobacco products, and new smokers begin using cigarettes every day. Cigarette manufacturers have developed various product modifications in an attempt to lower the adverse health effects of cigarette smoking and create so-called “reduced risk cigarettes.” Such modifications include the addition and improvement of filters for cigarettes and reducing the amount of tar contained in a cigarette. In addition, there is a debate as to the relative adverse health effects of menthol versus non-menthol cigarettes. While many smokers have chosen to afford themselves of one or more of these means in an attempt to reduce the adverse health effects of their smoking habit, few in depth, comprehensive studies have been conducted to ascertain, with any reasonable degree of certainty, the relative health effects/impacts of the various means that have been implemented to lower the health risks associated with cigarette smoking.

A comprehensive study of the relative health effects of so-called “reduced risk” cigarettes versus other cigarettes requires a long term examination of cigarette use. Such an examination must identify not only how long and how much individual respondents smoked, but also what type(s) of cigarette the respondents smoked. Moreover, an accurate and reliable assessment of the relative health effects of different types of cigarettes cannot be conducted in a vacuum. Other health-affecting aspects of the respondent's lifestyle must be taken into account as well so that judgments can be made as to the extent to which various health effects are due to cigarette use or other causes.

### SUMMARY OF THE INVENTION

The present invention provides a system and methodology, including software, for gathering reliable and comprehensive retrospective autobiographical information concerning events and conditions in the life of a study respondent, including comprehensive information on the use of specific types of consumer products and/or exposures to particular substances throughout the respondent's life. Such information can be useful in conducting epidemiological studies involving the health affects of various consumer product uses and/or substance exposures. In a particular application described herein and which address the issues raise above, the invention can be employed to gather retrospective autobiographical information concerning various health-affecting aspects of the respondent's life, including information concerning the specific types and amounts of cigarette products used by the respondent. An application of the system and method described herein is in the development and administration of an observational, retrospective, epidemiological case-control study designed to compare the risks of developing lung cancer associated with the use of ultra-low tar cigarettes (3 mg or less tar per cigarette) and full flavor cigarettes (10 mg or more tar per cigarette).

In gathering information concerning respondent use of or exposure to consumer products or substances from specific sources, images of source-identifying features are displayed to the respondent to assist the respondent in recalling the source or sources of the consumer products or substances the respondent used. In one embodiment, information concerning various characteristics of the consumer products or substances recalled by the respondent, for example, the country of purchase and/or color(s) of the product or its packaging, are used to locate, within a database, all consumer products or substances for which those characteristics are applicable. The source-identifying features of the located consumer products are then displayed to the respondent with the expectation that upon viewing and recognizing certain source-identifying features, the respondent will recall the source or sources of the consumer product or substances the respondent used.

Aspects of the present invention are embodied in, for example, a computer-implemented method of collecting retrospective, autobiographical data from a respondent utilizing a computer aided interviewing system, an article comprising a computer readable medium having software stored thereon including instructions for controlling a computer aided interviewing system, and a computer-aided interviewing system for facilitating the collection of retrospective autobiographical data from a respondent.

### DESCRIPTION OF THE DRAWINGS

FIG. 1 is a screen shot of a graphic user interface enabling a user to select the country in which the event history calendar questionnaire will be administered;

FIG. 2 is a screen shot of a graphic user interface enabling a user to enter case-identifying data;

FIG. 3 is a screen shot of a graphic user interface for administering cognitive capacity questions to a respondent;

FIG. 4 illustrates a graphic design comprising part of a cognitive capacity question;

FIG. 5 shows correct and incorrect response alternatives to a question asking the respondent to duplicate the graphic design shown in FIG. 4;

FIG. 6 is a screen shot of a graphic user interface showing a timeline for the residence domain of the questionnaire;

FIG. 7 is a screen shot showing a graphic user interface with a domain timeline and a superimposed instruction screen;

FIG. 8 is a screen shot showing a response window for entering address details for the residence domain;

FIG. 9 is a screen shot showing a response window for entering setting details for the residence domain;

FIG. 10 is a screen shot showing a response window for entering population density information for the residence domain;

FIG. 11 is a screen shot showing a response window for entering the name or initials of a marriage partner for the life events domain;

FIG. 12 is a screen shot showing a response window for entering marriage events in the life events domain;

FIG. 13 is a response window for entering the name or initials of any non-spousal partners in the life events domain;

FIG. 14 is a screen shot showing a response window for entering information regarding the respondent's children in the life events domain;

FIG. 15 is a screen shot showing a response window for recording deaths of important persons in the life events domain;

FIG. 16 is a screen shot showing a response window for entering the number of persons living in a dwelling in the life events domain;

FIG. 17 is a screen shot showing a response window for entering the number of smokers in the household in the life events domain;

FIG. 18 is a screen shot showing a response window for entering the level of schooling in the education domain;

FIG. 19 is a screen shot showing a response window for entering the highest educational level achieved in the education domain;

FIG. 20 is a screen shot showing a response window for entering information concerning diet in the health domain;

FIG. 21 is a screen shot showing a response window for entering the level of fruits and vegetables in the diet within the health domain;

FIG. 22 is a screen shot showing a response window for entering the level of fatty foods in the diet within the health domain;

FIG. 23 is a screen shot showing a response window for entering the level of alcohol use within the health domain;

FIG. 24 is a screen shot showing a response window for entering weight information within the health domain;

FIG. 25 is a screen shot showing a response window for entering chronic lung disease information within the health domain;

FIG. 26 is a screen shot showing a response window for entering chronic vascular disease information within the health domain;

FIG. 27 is a screen shot showing a response window for entering coronary or heart disease information within the health domain;

FIG. 28 is a screen shot showing a response window for entering cancer information within the health domain;

FIG. 29 is a screen shot showing a response window for entering diabetes information within the health domain;

FIG. 30 is a screen shot showing a timeline for cigarette use;

FIG. 31 is a screen shot of a cigarette brand selection screen;

FIG. 32 is a screen shot showing the cigarette brand selection screen showing images of actual cigarette packages;

FIG. 33 is a screen shot showing a response window for entering unlisted brand details;

FIG. 34 is a screen shot showing a response window for entering a cigarette brand;

FIG. 35 is a screen shot showing a response window for adjusting cigarette brand use percentages;

FIG. 36 is a screen shot showing the tobacco history timeline with brand and volume usage information entered therein;

FIG. 37 is a schematic view of a system for implementing the computer aided event history calendar of the present invention.

### DETAILED DESCRIPTION OF THE PREFERRED EMBODIMENT

The invention is described herein with reference to the accompanying drawings. The embodiment of the invention described herein and shown in the drawings is illustrative and should not be considered limiting on the scope of the invention.

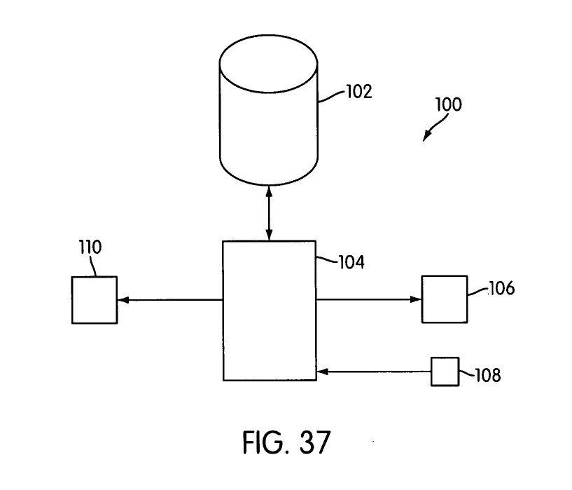

A preferred system for conducting a computer aided EHC questionnaire in accordance with the present invention, will be referred to as the computer-aided instrument, or “CAI,” and is represented schematically in FIG. 37. The system, or CAI, 100 generally includes a data storage system 102, a processor system 104, an interviewer display system 106, an interviewer input system 108, and a respondent (or subject) display system 110.

Data relating to questions, interviewer input screens, formats for graphical user interfaces (GUIs), and all other aspects associated with the implementation of the computer-aided EHC are stored in data storage system 102. Client responses and saved interviewer inputs are also stored in data storage system 102. Data storage system 102 may comprise any electronic storage means capable of storing digital data and may include, for example, portable memory devices (e.g., CD or memory stick), fixed memory devices (e.g., a computer hard drive), or remote memory devices. Data storage system 102 does not necessarily comprise a single memory device or location, and different stored data may be stored in different memory components which make up the data storage system 102.

The CAI 100 further includes processor system 104, which may comprise a computer processor (e.g., a central processing unit (“CPU”)), communicates with the other components of the CAI 100 and retrieves and processes instructions from the data storage system 102, and receives, processes, and, if applicable, stores in the data storage system 102, input from the interviewer input system 108. The processor system 104 also generates displays at the interviewer display system 106 and the respondent display system 110 based on data retrieved from the data storage system 102 and/or data entered at the interviewer input system 108.

The interviewer display system 106 displays interviewer GUI elements of the computer aided EHC to the interviewer. The interviewer GUI elements may include questions, timelines, instructions and suggestions, and input areas for accepting interviewer inputs of respondent responses and interviewer instructions. The interviewer display system 106 may include one or more devices for audio, video, and/or graphics presentation, and, in a preferred embodiment, comprises a graphics monitor.

The interviewer input system 108 facilitates interviewer informational input into the CAI 100. Such input may, for example, include respondent responses (e.g., answers to questions), interviewer instructions (e.g., proceed to the next question), and interviewer queries (e.g., interviewer help requests). The interviewer input system 108 may include one or more electronic input devices, such as, for example, keyboard, computer mouse, light pen, touch screen, microphone for voice activated input and/or to create an audio recording of the interview, bar code reader, radio-frequency scanner, etc.

The respondent display system 110 displays respondent GUI elements of the computer aided EHC to the interviewer. The respondent GUI elements, which are preferably under the control of the interviewer through the commands entered at the interviewer input system 108, may include questions, timelines, and instructions. The respondent display system 110 may include one or more devices for audio, video, and/or graphics presentation, and, in a preferred embodiment, comprises a graphics monitor. In the illustrated embodiment, the interviewer display system 106 and the respondent display system 110 comprise separate systems, but it is contemplated that the interviewer display system and the respondent display system could comprise the same system with the interviewer and the respondent-respondent viewing the same displayed information.

The CAI 100 illustrated in FIG. 37 does not include a respondent input system, and the preferred implementation of the computer-aided EHC of the present invention does not require inputs by the respondent, as all inputs are entered by the interviewer (or an interviewer's assistant who is present at the interview). Nevertheless, it is contemplated that certain applications of the computer aided EHC may be facilitated by providing a respondent input system and permitting the respondent to enter certain information directly into the CAI.

In a preferred embodiment, the CAI 100 comprises two computers, an interviewer computer and respondent computer, linked together as a mini workgroup. The two computers are preferably portable computers, such as notebook or hand-held computers, so that CAI can be taken directly to the respondent for conducting the interview. As noted above, the two computers will serve different roles and therefore will require a different screen layout on each. The interviewer computer will be utilized by the interviewer for data entry and navigation between questions, and the respondent computer will be used a visual aid to the respondent. Each of the computers can be any device capable of processing data, such as, for example, computers based on technology from Apple Computer (e.g., The Macintosh, the PowerMac series, etc.) or technology based on processors by Intel, AMD, Cyrix, etc. and commonly referred to as IBM compatibles. It should be noted, however, that at least the respondent “computer” need not be an actual computer (i.e., a machine with processing power); a so-called “dummy terminal” may be sufficient if it is linked to and controlled by the interviewer computer.

The application can be implemented via software programmed in any suitable programming language known to or developed by persons of ordinary skill in the art, such as, for example, Microsoft Visual Basic or Java, whereby GUI's employed in the application are programmed as Java applets. Storage and database management requirements can be met using any suitable database system known to or developed by persons of ordinary skill in the art, such as, for example, Microsoft Access and MySQL database systems.

In some embodiments, the various methods described herein may be implemented in computer program products for use with a computer system. This implementation may, for example, include a series of computer instructions fixed on a computer readable medium (e.g., a diskette, a CD-ROM, ROM, or the like) or transmittable to a computer system via an interface device, such as a modem or the like. The transmission medium may be substantially tangible (e.g., communication lines) and/or substantially intangible (e.g., wireless media using microwave, light, infrared, etc.). The computer instructions can be written in various programming languages known to or developed by persons of skill in the art and/or can be stored in memory device(s) known to or developed by persons of skill in the art, such as semiconductor devices (e.g., chips or circuits), magnetic devices, optical devices and/or other memory devices. In the various embodiments, the transmission may use any appropriate communications technology.

The present invention will be described in the context of a computer aided EHC application developed to collect lifestyle and smoking data from smokers. This application is intended to be illustrative and exemplary only; the current invention could be employed in other applications for collecting retrospective information, including retrospective consumer product usage information, and need not necessarily be implemented with the aid of a computer.

An exemplary embodiment of a computer-aided EHC which embodies aspects of the present invention will be described below.

The Country Selection Screen

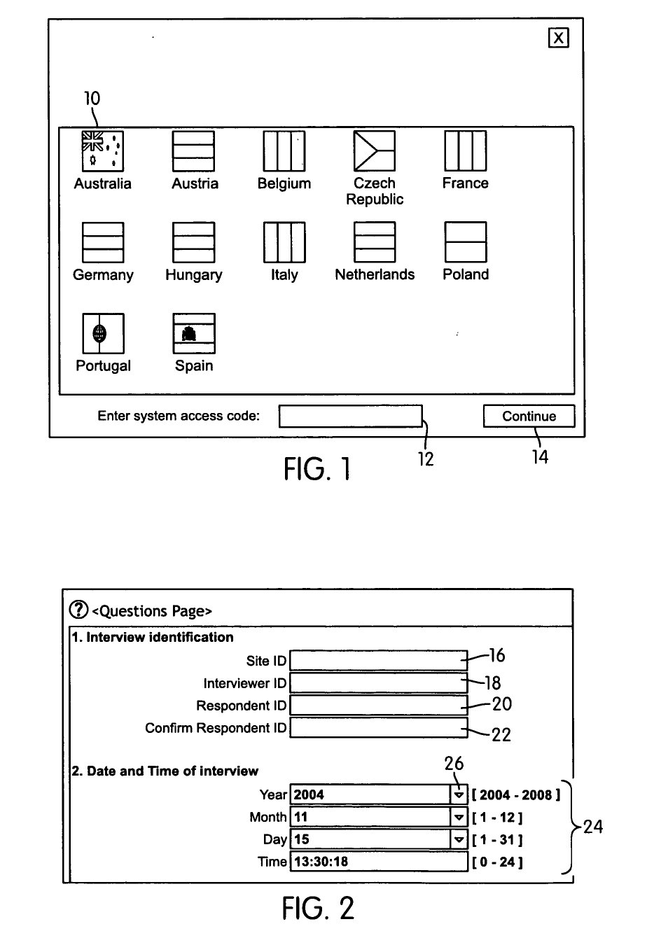

The system and method of the present invention can be applied within the cultural and language variations of different countries. Accordingly, the computer-aided EHC is preferably customized in terms of language and cultural norms to different countries in which gathering of personal history information may be desired. To provide the interviewer with a country-appropriate questionnaire, the application preferably opens with the Country Selection screen, as shown in FIG. 1. Here, the user may decide which country the application will be optimized for. The selection can be made, for example, by moving the mouse cursor over an appropriate country name or flag 10 displayed on the country selection screen and selecting the desired country.

The interviewer must enter a secure user ID (or system access code) into the field 12 provided at the bottom of the screen.

To progress to the next screen, the button marked “Continue” must be pressed.

If the continue button 14 is pressed without a country having been selected and a secure user ID having been entered, a prompt will appear on the screen asking for a country to be chosen.

Main Options Screen

The next screen of the application is the main options screen (not shown), which in a preferred embodiment is substantially blank with icons (or buttons) at the margin that permit the user to start a NEW questionnaire, OPEN an existing questionnaire, WRITE to a CD the results of previous questionnaire, or ask for HELP with the application. A RECORD icon may be provided and is typically inactive at this stage of the application, but can potentially become active during the next few stages. There is also an EXIT button, for closing down the application.

Starting a New Questionnaire

By clicking the NEW button in the main options screen, the application launches a new questionnaire. The first question is intended to capture details about the interview, including its location, who is taking part, and when it actually happened. All of this data is recorded on the screen, as shown in FIG. 2 which appears after clicking the NEW button on the main options screen.

First, the site ID 16 of the interview must be recorded, followed by the interviewer ID 18 and the respondent ID 20. The respondent ID must be entered a second time at 22, for confirmation. The screen will not display the characters entered during the confirmation. If the IDs match, then the computer-aided instrument will allow the next questions to be answered—if there is a discrepancy between the two, it will display a warning to this effect, and prompt for the correct respondent IDs to be input.

In a preferred embodiment, the details of question 2, date and time of interview will already appear completed on the screen at 24. If the information that appears in question 2 is incorrect for any reason, it can be amended by either selecting a new option from the click down menu 26, accessible, if appropriate, by pressing a down-arrow button alongside the information field, as is the case for changing the year, month and day, or by typing the correct information into the data field, as is the case for time.

An introductory questions screen (not shown) provides a choice of either male or female for choosing the gender of the respondent and captures the year and month of the respondent's birth. The computer-aided instrument (“CAI”) will display the respondent's current age once the birth year and month data have been entered. Another introductory question prompts for the country and state or province in which the respondent currently resides. A sequence of drop-down menus is preferably provided, and the available options for each one will be determined by the selection made from the previous list.

In the preferred embodiment, all of the questions on this screen are mandatory. If the CONTINUE button is pressed before all the required fields have been completed, a warning will appear advising the user that some fields have been left unfilled, and that they must be completed before the CAI will allow the questionnaire to progress.

Cognitive Capacity Assessment

The accuracy of the information gathering process of the present invention relies heavily on the memory of the respondent. Accordingly, it is beneficial, prior to beginning the questionnaire, to asses the respondent's cognitive capacity. The questions which should be relatively easy for the respondent to answer accurately and include questions ranging from “what year/season/month/day/date is this?” to questions asking the respondent to identify a common item displayed to the respondent, such as a pencil or wristwatch. Moreover, an application of the present invention is in gathering information regarding lifestyle, health, and tobacco use of long-time smokers. In many cases, such respondents may be of advanced age and/or poor health, and the respondents' answers to such cognitive questions can help the interviewer assess the cognitive capacity of the respondent. In a preferred embodiment, the respondent is asked a series of questions from an examination known as the Standardized Mini-Mental State Examination (“SMMSE”) developed by Dr. David William Molloy, Dr. Efrem Alemayebu, and Dr. Robin Roberts (Canadian Copyright Registration Number: 407463), the contents of which are hereby incorporated by reference. Points are awarded to the respondent for each answer depending on whether the answer is correct, incorrect (or no answer given), or partially correct. Failure by the respondent to achieve a minimum threshold score will suggest that the respondent's cognitive capacity is not adequate to impart a reasonable degree of confidence in the accuracy and reliability of the information the respondent is about to be asked to give. Accordingly, if the respondent fails to achieve a minimum threshold score, the calendar questions section (described below) of the questionnaire is not completed with that respondent.

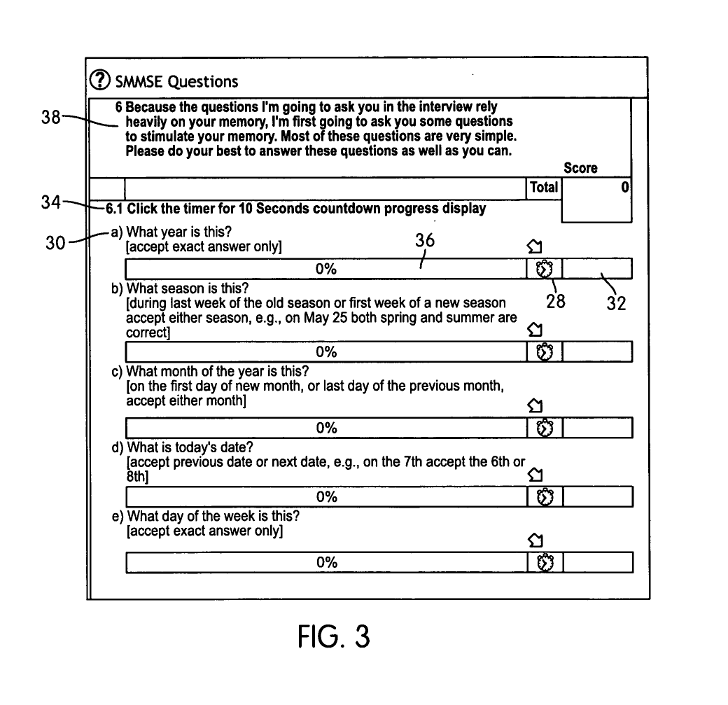

Once the introductory questions (interview date, time, and location; respondent sex, age, current residence) data has been captured, the questionnaire displays the cognitive capacity questions, which are split into sections. (See FIG. 3). Each section features some common elements, namely some question text 30, an area for selecting the score achieved by the respondent's answers 32, and some instructions text 34, in which the interviewer may find extra information regarding the scoring system for a particular question, or extra instructions needed for the respondent to successfully reply to the question. An explanatory statement 38 for the interviewer to read to the respondent may be provided. In order to progress through the sections, the interviewer asks each question in turn, recording the result in each case, and presses the CONTINUE button located in the bottom right-hand corner of the screen once the last question of each section has been asked.

The sections of the cognitive capacity questions follow several different formats. Some questions involve simply asking the respondent a question, and then selecting a score for each response. A scoring guide is provided for each question. Other questions follow a different pattern. For example, one question will require the interviewer to input the spelling of a specified word given by the respondent into the text input box located alongside the score box. Once the spelling has been typed, the interviewer can press the “enter” button on the keyboard, and the application will then provide the appropriate score for the spelling given.

Still other questions will require the respondent to identify by name an item that is shown to them, for example a wristwatch or a pencil. The application features a button to display such items to be identified on the respondent's screen. When these buttons (which initially read “show [item] on respondent screen”) are pressed, the corresponding item is displayed on a screen before the respondent, and the text on the button changes to read, for example, “hide [item] on respondent screen”. Again, a score box is provided for the interviewer to select the score appropriate to the respondent's responses.

In one embodiment, a timer button, or icon 28, may be provided on the interviewer's screen next to the question. A respondent may, for example, be required to answer a question within 10 seconds. Selecting the timer button will cause a progress bar 36 to mark out how much time remains for the respondent to provide an answer for that particular question. Use of the timer is not compulsory. Preferably response and scores can be entered for questions without using the timer, during timer's progress, and after the timer has finished. In a preferred embodiment the timer is omitted altogether.

Another question contains an option box for selecting which response is given to the question of being left- or right-handed. Once the selection is made, the text which follows this selection will alter depending on the response given. The question will ask the respondent to take a piece of paper with the opposite hand to that specified as their strongest hand, fold the paper in half once with both hands, and put the paper down on his/her lap. As with most of the previous questions, a score box is provided for the interviewer to select the score appropriate to the respondent's responses.

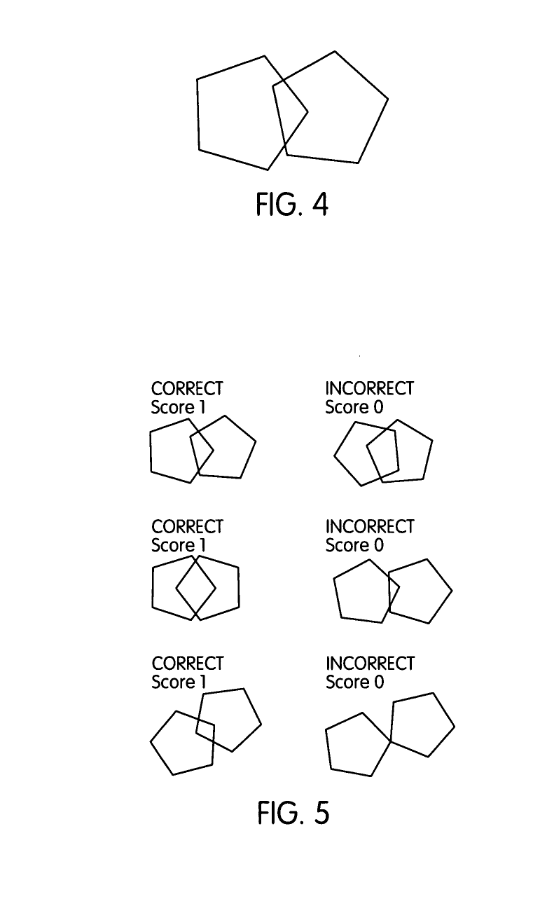

The last item in the cognitive capacity questions requires an image to be shown to the respondent. This is done by pressing a button provided in this question. In a preferred embodiment a design comprising two pentagons will appear on the respondent's screen as shown in FIG. 4. The respondent is then given paper and pencil and asked to copy the design. Once the button has been pressed, the text for that button will change to “hide design”, and can be pressed again to remove the image from the respondent's screen. Following the last question is a visual aid for the interviewer for scoring the attempt by the respondent (see FIG. 5).

Pressing the continue button (not shown), located in the bottom right-hand corner of the screen, at this stage will cause the CAI to calculate the total cognitive capacity score achieved by the respondent, and move the questionnaire onto an appropriate point based on that score. If a shorter questionnaire would be more appropriate (i.e., if the respondent's score did not meet a predefined minimum threshold), the CAI will display a shorter version of the socioeconomic and smoking history questions (described below) before finishing the questionnaire. If the score is high enough, the CAI will proceed to the recording consent screen.

Recording Screen

A recording screen (not shown) is where the consent will be logged for the questionnaire session to be recorded. Also, minor setup adjustments can be made on this screen. The respondent is asked for permission to electronically record the interview, and the interviewer selects the response from one of the two consent options (YES/NO) given. If the response is “no,” then the RECORD, PLAY, and ADJUST buttons will be deactivated by the CAI; no recordings will be made. The “grayed out” (i.e., inactive) RECORD button at the top of the screen will remain un-selectable throughout the questionnaire. Also, the recording indicator at the bottom of the screen will remain in the “off” setting to confirm no recording is being made.

A “continue” button in the bottom right hand corner of the screen can then be pressed to proceed with the questionnaire without recording.

If the response is “Yes,” then the remaining instructions on the screen can be followed, and buttons are provided to RECORD, STOP, PLAY, and ADJUST as desired. Once the record feature has been tested and adjusted as necessary, the CONTINUE button in the bottom right hand corner of the screen can be pressed, to take the interviewer to the questionnaire proper. When the RECORD button has been pressed a recording indicator at the bottom of the screen will show that recording is taking place. Recording can, if desire, be stopped and started as necessary during the interview.

Calendar Questions

In the preferred embodiment of the invention, the main body of the questionnaire is focused on a series of “calendar questions”, whereby answers to questions are stored in combination with a year or range of years. The questions are logically grouped into domains of questions relating to similar subjects concerning aspects of the respondent's life, such as: residence, life events, education, occupation, tobacco history, health, and medical history.

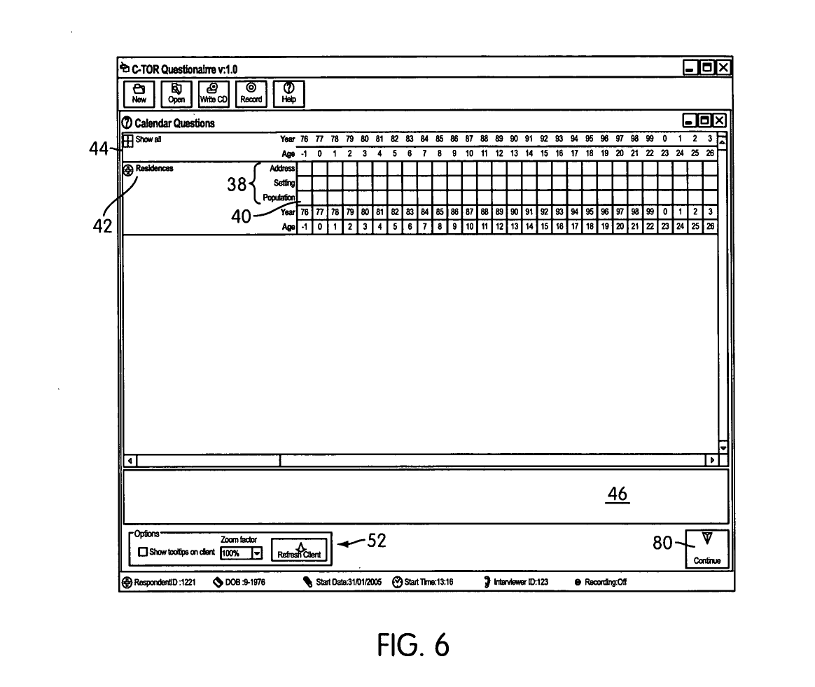

The calendar questions window is shown in FIG. 6.

At the top of the window is a panel 44 displaying a series of years and ages calculated by the computer-aided instrument from the information provided by the respondent regarding their birth month and year. Below this information are the questions 38 which make up the questionnaire. In FIG. 6 the first domain to be completed, the residence domain 42, can be seen. This domain should be completed before moving on to the remaining domains.

Each of the questions 38 in a domain is called a timeline, while each of the white boxes 40 that can be seen along each timeline is called a “cell”. The cell represents one year on a particular timeline—the year can be ascertained by reading up from the cell to the year which appears in the text area above and below the timeline. The computer-aided instrument will automatically create timelines of the correct size for the respondent, based on their answer to the earlier year and month of birth question.

Notice that in the illustrated example of FIG. 6, which was generated by using the year 1976, and month of birth as month 9, that 1976 is given as age −1. This is to reflect that the respondent was alive in this year for less than half a year. The age timeline is populated with the age the respondent was for the majority of a given year, for example, for the majority of year 77 the respondent hadn't reached their first birthday, so for the majority of the year they were age 0. By year 78, they had reached their first birthday, and spent the majority of the year age 1.

Some of the questions will require just one cell at a time to be selected on the timeline, while others will require the interviewer to select a range of cells. This is accomplished, for example, by moving the mouse pointer to the cell that represents the starting year of the range, and the pressing the left mouse button down. While holding the left mouse button down, the mouse is moved along the timeline until the mouse reaches the final year in the range required. Releasing the left mouse button at this point will bring up the response screen for that timeline indicating the selected range. If a single cell is required, the mouse cursor can be moved to the appropriate cell, and left mouse button clicked once. Timelines that require only a single cell to be selected at a time will not allow the interviewer to select a range of cells. If the interviewer attempts to do so, a warning will appear on screen advising the interviewer to make a new selection.

Once the data for the range has been entered, the computer-aided instrument will automatically ensure the data is captured and presented on the interviewer and respondent screens across the whole range.

Once a cell or range of cells has been selected and completed, it is possible to both amend the contents of the cell(s) as well as the size and location of the cell(s). For example, a respondent may indicate that a particular range was actually 3 years longer than originally thought. In this instance, it is possible to resize the cell range by moving the mouse pointer to either the first or last cell in the range, and holding down the middle mouse button (this might be a scroll wheel). While the middle mouse button is being pressed down, the mouse pointer is moved to the cell that represents the new end of the range, and the middle mouse button released. The cell range will be resized. If the selection of a cell or range of cells includes cells already completed, a pop-up menu will appear giving options of overwriting the already completed cells, deleting the range, or canceling the instruction.

Timelines do not have to be completed in chronological order: for example, some respondents find it easier to work backwards from the present-day when remembering previous events. To this end, the interviewer can start a timeline entry at any position along its length.

Once a section of a timeline has been completed, the respondent screen will be updated automatically with the view of the completed calendar as it appears on the interviewer screen. Clicking onto a new timeline will also update the view, as will selecting the REFRESH CLIENT control (see below).

Note in FIG. 6 how the residence domain 42 is already visible. The timelines for all domains can be called to the screen instantly by pressing the “show all” button in panel 44, located above the first domain. When activated, this button's name will change to “collapse all.” After it has been used once, the “show all” label changes to become “expand all.”

The area 46 at the bottom of the screen is the information panel. This area displays information of different types for the interviewer. By moving the mouse pointer over different parts of the screen, the interviewer can access the information. For example, by moving the mouse pointer over the years at the top and bottom of the calendar screen, the interviewer can see some landmark historical events from that year. By moving the mouse pointer over completed calendar data, the interviewer can see the data that was input for that timeline.

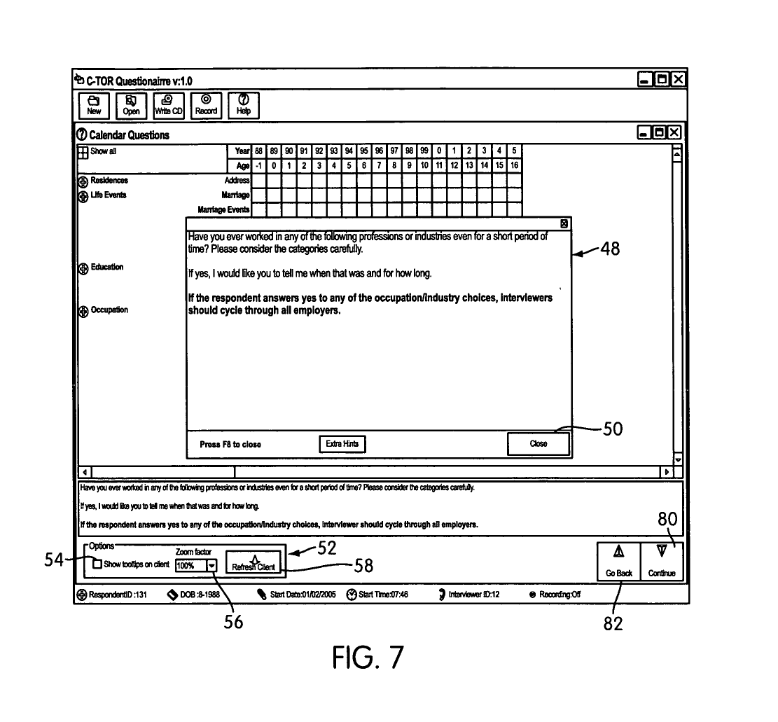

In order to view the question text for a particular timeline, the interviewer must click the left mouse button on the timeline title (or press the a key on the keyboard (e.g., the F8 function key) while the mouse pointer is over the timeline title) and an instructions window 48 will appear, which contains not only the introductory script and question text (which also appears on the information panel), but also any additional reminders, completion criteria or probing questions which might be appropriate. See FIG. 7 for an example in the occupation domain. To remove the instructions window there is a CLOSE button 50, or the interviewer may choose to press the F8 key, which also closes the instruction window. Also, if the interviewer wishes to see the area of the calendar directly under the instructions window 48, they may move the mouse pointer away from the instruction window, and the window will become transparent. To restore it, the interviewer simply has to move the mouse pointer back over the instructions window 48.

Below the information panel is an area 52 displaying some buttons and other controls. The first button, show tooltips on client 54, will allow the respondent screen to display whatever is shown in the information panel 46. This should be used sparingly as it can cause the respondent screen to switch rapidly between different data, which may be unpleasant to the respondent. The second, zoom factor 56, controls the level of zoom that is used to display the calendar screen. This feature can be useful for both shrinking the calendar, to allow more of each timeline to fit on the screen, and for enlarging the calendar, to be able to discern details in each timeline. A 3rd use is linked to the final of this group of controls, refresh client 58. Refresh client 58 will allow the interviewer to update the respondent's screen with the calendar screen as it appears on his or her own screen. For example, if a respondent indicates that they cannot make out the detail in a timeline, the interviewer can use the zoom factor control to increase the size of the timeline, and use the scroll bars if necessary to position the calendar at the appropriate location, and then press the refresh client button. The respondent will then have the larger image on their screen, and the interviewer can return their screen to the size it was previously, to allow them to continue as before. It is also possible to resize the viewing area on screen by pressing the CTRL button down and rolling the mouse wheel at the same time. The changes to the visible area can be displayed on the respondent screen by using the refresh client control.

Residence Domain

Upon arriving at the calendar questions section of the questionnaire, the only domain visible is the residence domain 42 (See FIG. 6). Some of the timelines are exhaustive, which means that the whole timeline needs to have answers provided, whether through one large range, or several smaller ranges, and that there can be no gaps between the answer ranges. Others are not exhaustive, and so gaps are permissible in the timeline.

Within the residence timelines, it is preferred that when completing address details to use the minimum number of timelines. For example, if one address runs from 1978-1984, a second address runs from 1983-1998, and a third address ranges from 1999-2004, then all three addresses (or places of residence) can be successfully captured in just two residence timelines, with timeline one carrying the addresses from 1978-1984 and 1999-2004 and the second timeline carrying the address for the 1983-1998.

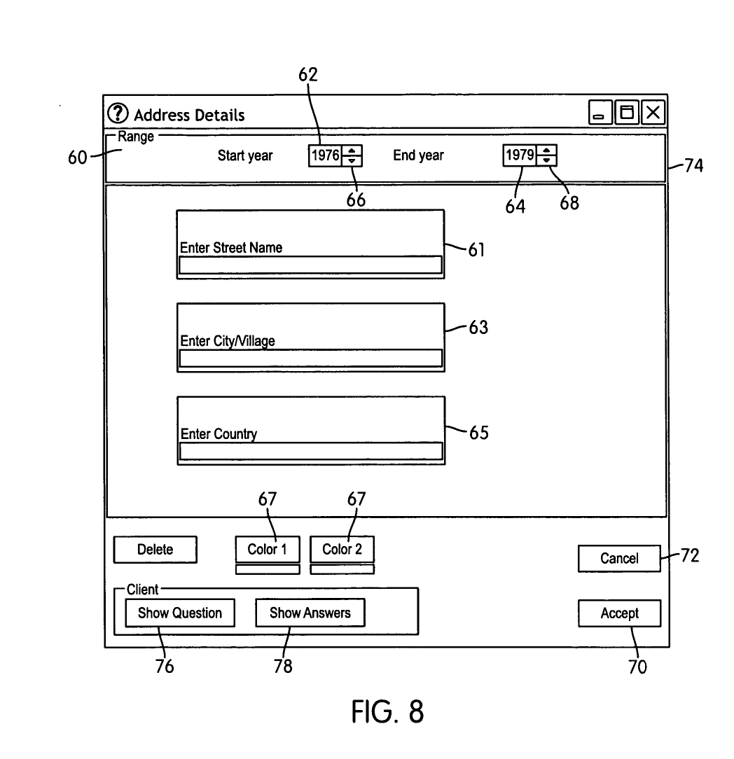

Whenever a cell or range of cells is selected, a response window indicating the selected start and end range will appear on the interviewer's screen to capture the relevant information. These response windows can take a number of different formats. The residence timeline response window 74 may, for example, require text to be typed into the boxes provided as shown in FIG. 8.

This response window also includes a number of other features. Note at the top of the window there is an area marked “range” 60, which features the starting year 62 and end year 64 for the range selected on the timeline, and these can be adjusted by clicking on the up and down arrows 66,68 located to the right of each year display on the response window. A new value for either year can also be provided by clicking on the text of the year and typing in a new value. If a value is entered which falls outside the lifetime of the respondent, the year will default to the earliest or latest applicable depending on whether it is before or after the respondent's lifetime.

Response window 74 includes response boxes for street name 61, city or village name 63, and country name 65. To enter the respondent's answers into the boxes 61, 63, 65 provided below each answer field, the interviewer simply moves the mouse to the relevant box and clicks the left mouse button to select the box, and then types the appropriate answer.

If the interviewer wishes to see the area of the calendar screen directly under the response window, they can make the response window transparent by moving the mouse pointer away from it. To return the response window back to normal, the interviewer simply moves the mouse pointer back over it. Once all the information has been gathered, the interviewer presses the ACCEPT button 70 located at the bottom right hand corner of the response window. If the timeline range has been selected in error, click the CANCEL 72 button located just above the ACCEPT button 70, and the response window will close with no answers updated in the timeline for that response. The response window 74 also includes a respondent control area with a show question button 76, which shows the current question on the respondent screen, and a show answer button 78, which shows the current answer on the respondent screen. Colors for the timeline displays at the respondent screen default to preselected colors. To adjust the colors, if desired, color buttons 67 are provided in response windows.

Once a residence timeline response has been captured, a second residence timeline will appear, to allow the interviewer to capture address details for a second home the respondent may have had at any time. In a preferred embodiment the application allows the interviewer to capture up to seven residential addresses for the respondent at any one time, with a new residence timeline appearing each time.

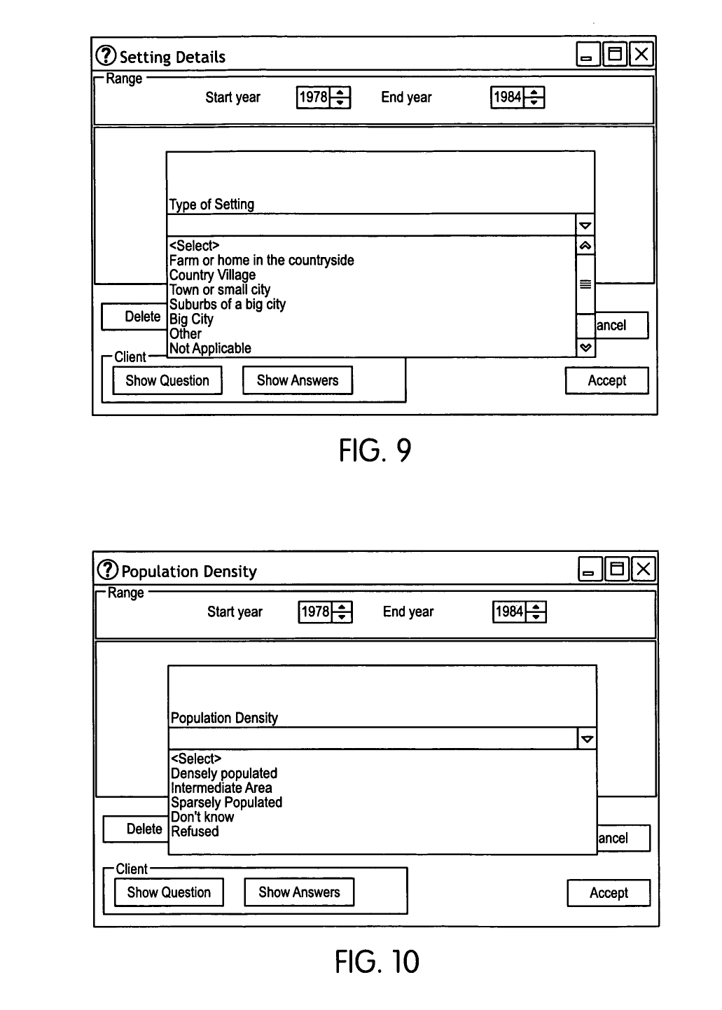

Once the residence timelines have been captured, there are 2 remaining questions in the residence domain: setting and population. Both of these timelines illustrate another type of response for the interviewer to complete, preferably selecting an appropriate response from a “drop-down” list. This is done by clicking the left mouse button on the down arrow that appears at the end of the input box and then clicking on the most appropriate response from the list that appears on screen. FIG. 9 shows a “setting details” dialog box with the drop-down menu activated, and FIG. 10 shows a “population density” dialog box with the drop-down menu activated. Exemplary possible responses for setting include: farm or home in the countryside, country village, town or small city, suburb of big city, big city, other, or not applicable (see FIG. 9). Exemplary possible responses for population include: densely populated, intermediate area, sparsely populated, not applicable, don't know, or refused (i.e., respondent refuses to provide the requested information) (see FIG. 10).

Once an answer has been provided in a cell, whether by selecting one cell or inputting an answer for a range of cells, that answer can be recalled easily by positioning the mouse cursor over the required cell. The information panel 46 (see FIG. 6) is updated with the corresponding data, and the instructions window can also be called up on screen at this point by, for example, pressing the F8 key. The instructions window will display the response selected for that particular cell or range.

When all the appropriate residence timelines have been completed, to call up the next domain, the CONTINUE button 80 is pressed. This then brings up another domain, which, in the preferred embodiment, is the life events domain. A go back button 82 takes the interviewer to a prior domain.

Life Events Domain

This domain features different timelines to those found in the residence domain. Exemplary life event timelines include marriage, marriage events, partners, children, deaths, persons in dwelling, and residential smoking. A description of each timeline and possible responses for each are set forth below.

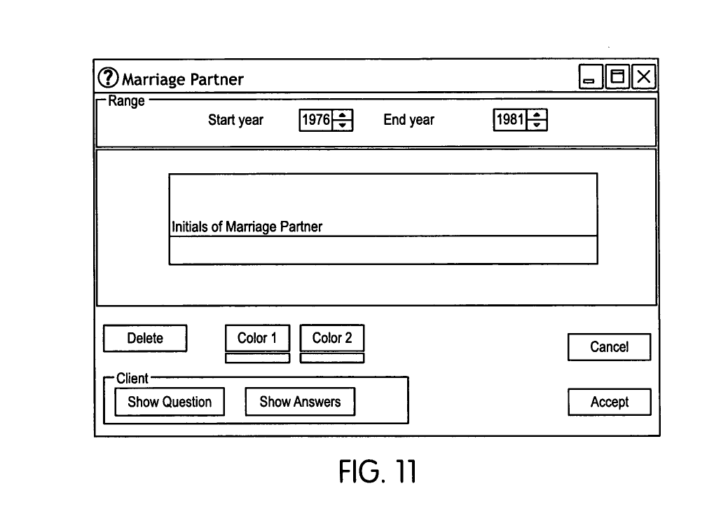

Marriage: This timeline accepts text entries, to record the name or initials of a marriage (spouse or registered partner) for the specified range of years. (See FIG. 11).

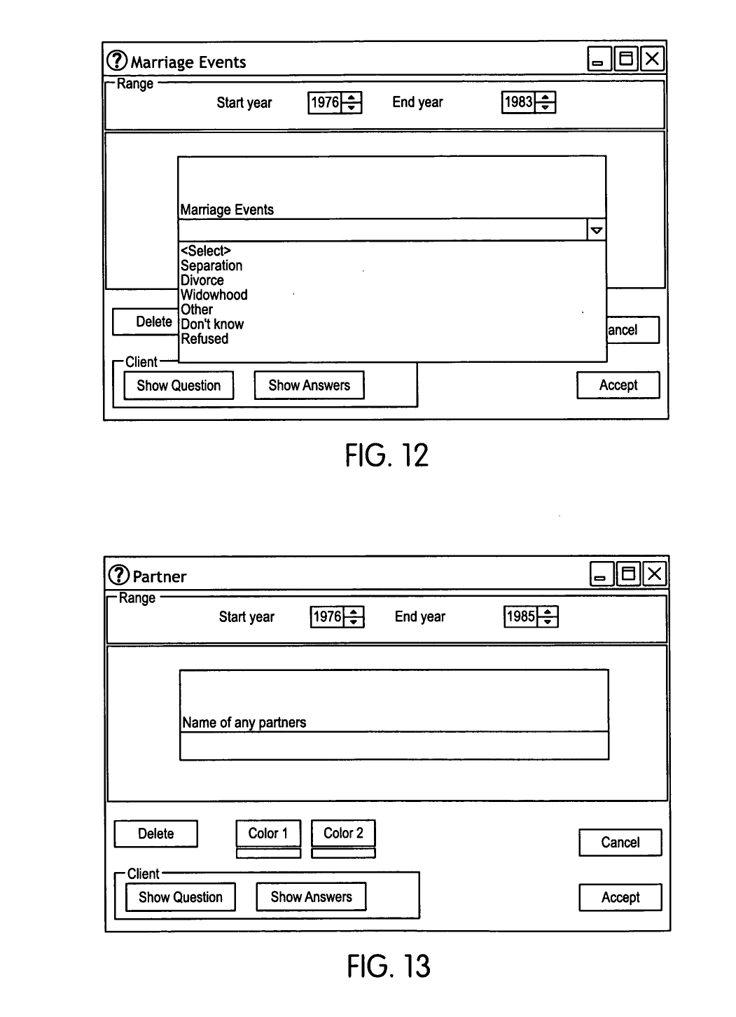

Marriage Events: This timeline presents a drop-down list of possible marriage events, with one to be selected from the options provided. Possible events include separation, divorce, widowhood, other, don't know, or refused. (See FIG. 12).

Partners: This timeline provides a text-entry response window to capture the name or initial of any partner the respondent lived with as though they were married. (See FIG. 13).

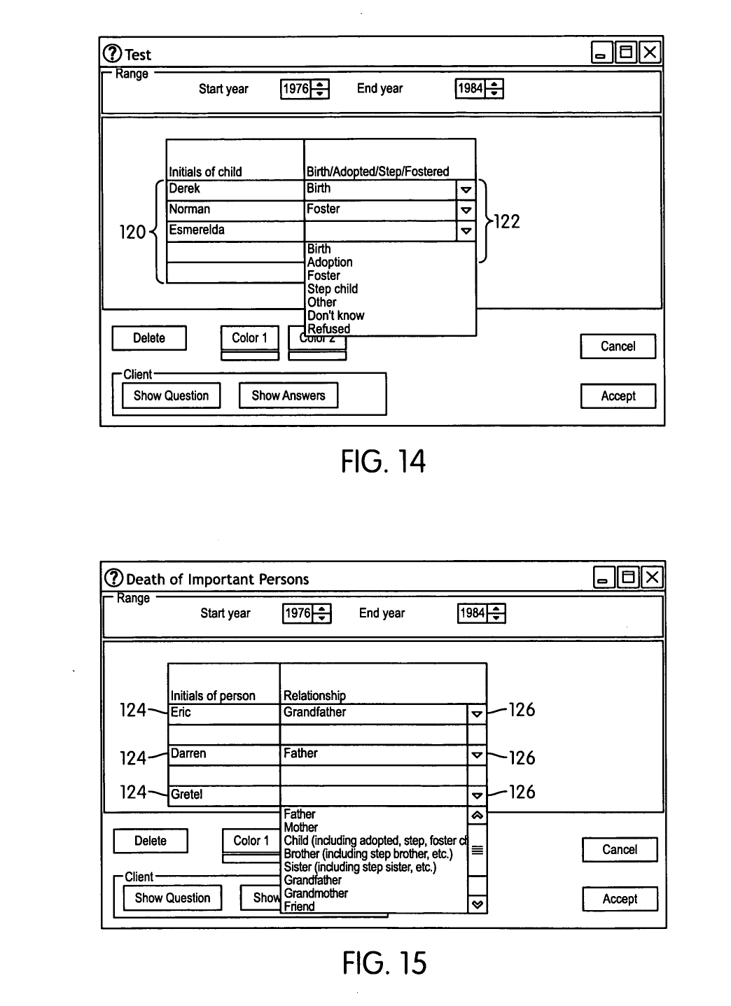

Children: The response window displayed by this timeline has a different layout to those presented so far (see FIG. 14). This response window provides a table into which it is possible to enter text for the name or initials of a child or children at 120, with a second box 122 alongside with a drop-down list of options for specifying how the child joined the family. Response options include: birth, adopted, step child, foster, other, don't know, and refused. (See FIG. 14).

Deaths: This timeline presents a similar response window to that of the children timeline. Here, the name or initials of the person who died can be typed into the text-entry box 124, and then the relationship of the deceased to the respondent can be chosen from the drop-down list of options provided at 126. Possible relationship options include: father, mother, child (including adopted, step, foster children), brother (including step brother, etc.), sister (including step sister, etc.), grandfather, grandmother, friend, other, don't know, and refused. (See FIG. 15).

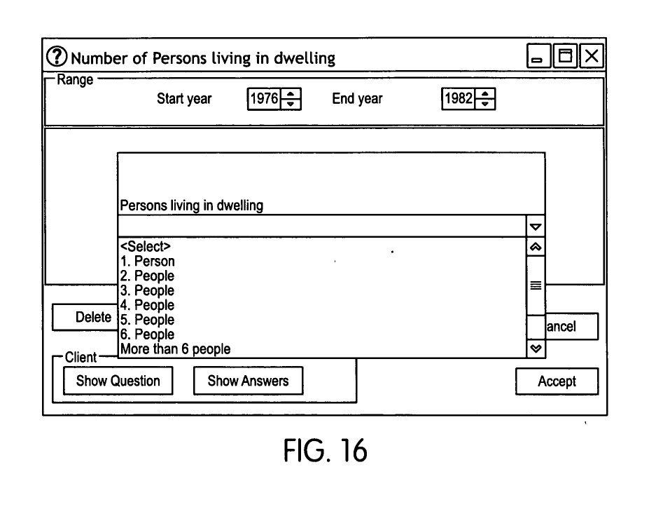

Persons in Dwelling: This timeline captures the number of people, including the respondent, who were living at the respondent's residence in any given year. It captures this data through a drop-down list from which it is possible to select one option from those offered. Options include 1 person, 2 people, 3 people, 4 people, 5 people, 6 people, more than 6 people, public institution, don't know, and refused. (See FIG. 16).

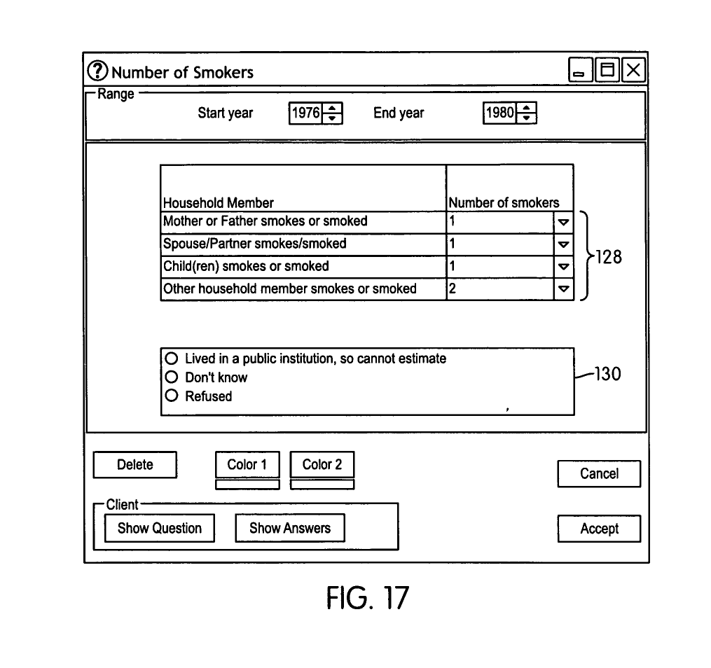

Residential Smoking: This timeline works differently from the others encountered so far (see FIG. 17). Although the response window it uses is quite large, the timeline itself will summarize the information captured in the response window down to a single figure: the number of smokers at any given residence at any given time. By selecting an option from each drop down list 128, the response window will keep track of how many smokers have been discussed so far. The response window also allows the interviewer to capture responses that fit one of the options in the box 130 at the foot of the window (e.g., that they lived in a public institution, don't know the answer, or refuse to answer). If an item from this box is selected, then any figures entered from the drop-down lists will be discounted, and the timeline will display “public institution, −1 (for don't know) or −2 (for refused to answer) as the total number of residential smokers. (See FIG. 17).

A glance at the residential smoking and persons living in dwelling timelines can quickly identify errors, by checking that the number of residential smokers does not exceed the number of people living at a particular dwelling at any given time.

Education Domain

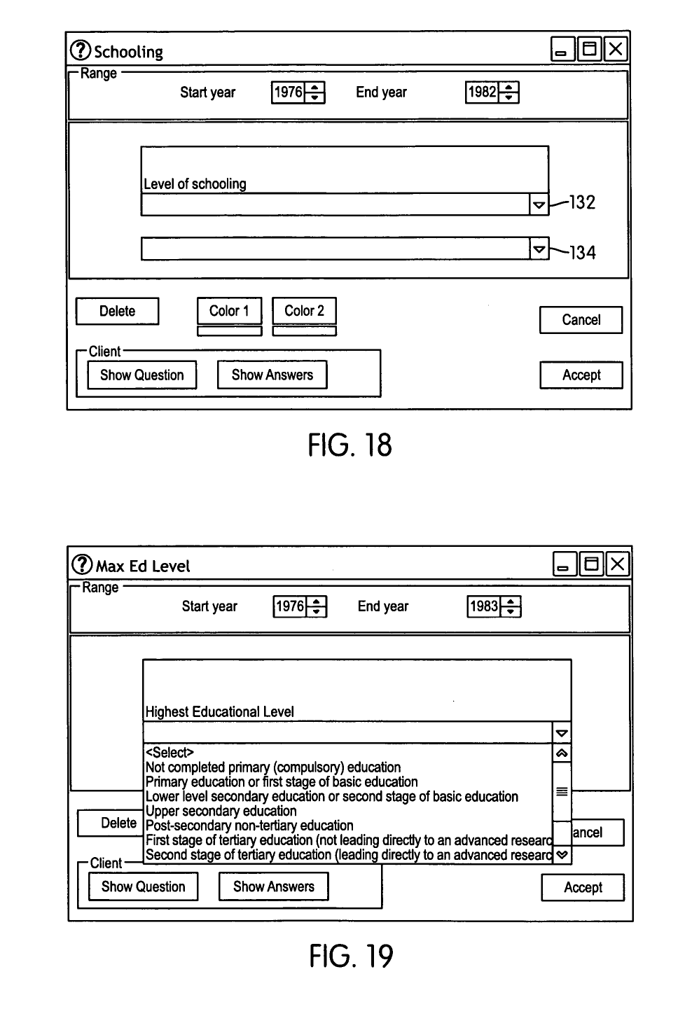

This domain preferably contains three timelines, two schooling timelines and one degree timeline. The schooling timelines present the response window shown in FIG. 18. The domain presents two schooling timelines 132, 134 to enable the interviewer to capture schooling details from those years where the respondent may have changed schooling level at some point during the year owing to the academic year not corresponding to the calendar year. The interviewer asks the respondent about those periods in which the respondent was attending elementary school, middle school, and secondary school. (Note that the appropriate schooling types will be automatically displayed based on the country of residence that the respondent has indicated in the introductory questions section. The customized response alternatives have been standardized based on the International Standard Classification of Education (ISCED)). The interviewer will also ask whether the respondent attended college or university, professional school, and/or graduate school. The responses, that is, levels of schooling and corresponding periods, are entered using the response window shown in FIG. 18, using the drop down menus to the extent possible to enter standard schooling levels.

The other timeline in this domain is the degree timeline. This presents a response window as shown in FIG. 19 with one drop-down list from which to select a response. The list of possible responses will be customized for the appropriate country based on the answers given by the respondent during the introductory questions section and standardized using ISCED:
Did not complete primary (compulsory) education
Primary education or first stage of basic education
Lower secondary education or second stage of basic education
Upper secondary education
Post-secondary, non-tertiary education
First stage of tertiary education (not leading directly to an advanced research qualification)
Second stage of tertiary education (leading directly to an advanced research qualification)
Don't know
Refused
   Health Domain

This domain captures information about the respondent's diet, alcohol consumption and weight. Each timeline presents a simple response window to be completed. The timelines are as follows:

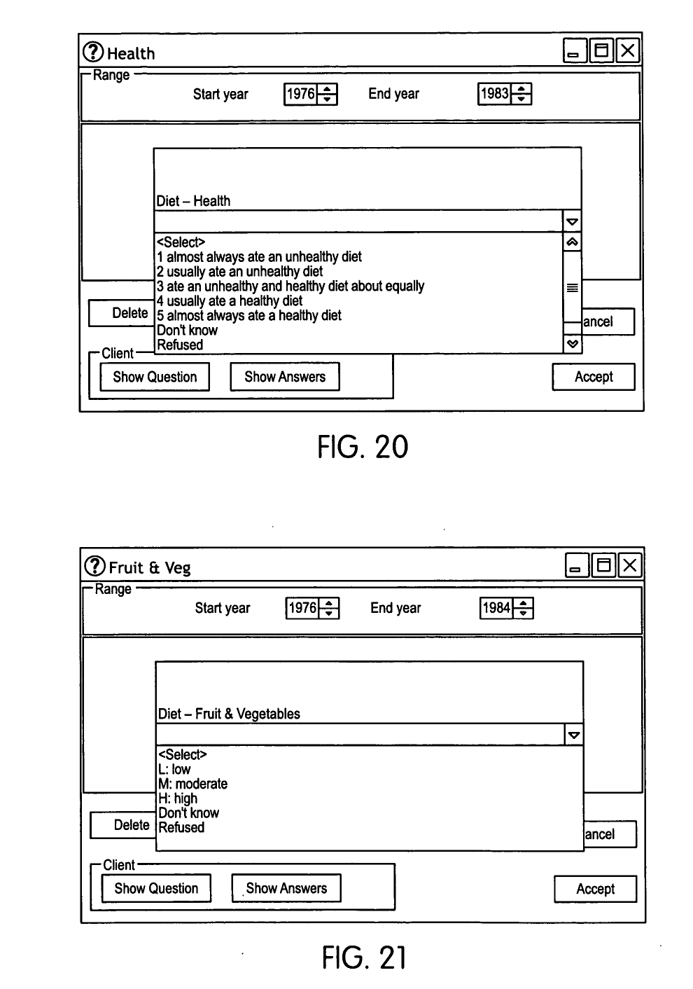

Health—Diet. As shown in FIG. 20, this asks the respondent to characterize the general healthiness of their diet for a given period, by choosing one of the following options:
almost always ate an unhealthy diet;
usually ate an unhealthy diet;
ate an unhealthy and healthy diet about equally;
usually ate a healthy diet;
almost always ate a healthy diet;
don't know;.
refuse

Health—Fruit and Vegetables. As shown in FIG. 21, this timeline captures information about the amount of fruit and vegetable consumption of the respondent at a given period. For example, a respondent may be asked to characterize their amount of fruit and vegetable consumption over a given period as low, moderate, high, or don't know, preferably with general definitions or guidelines given for each level to assist the respondent.

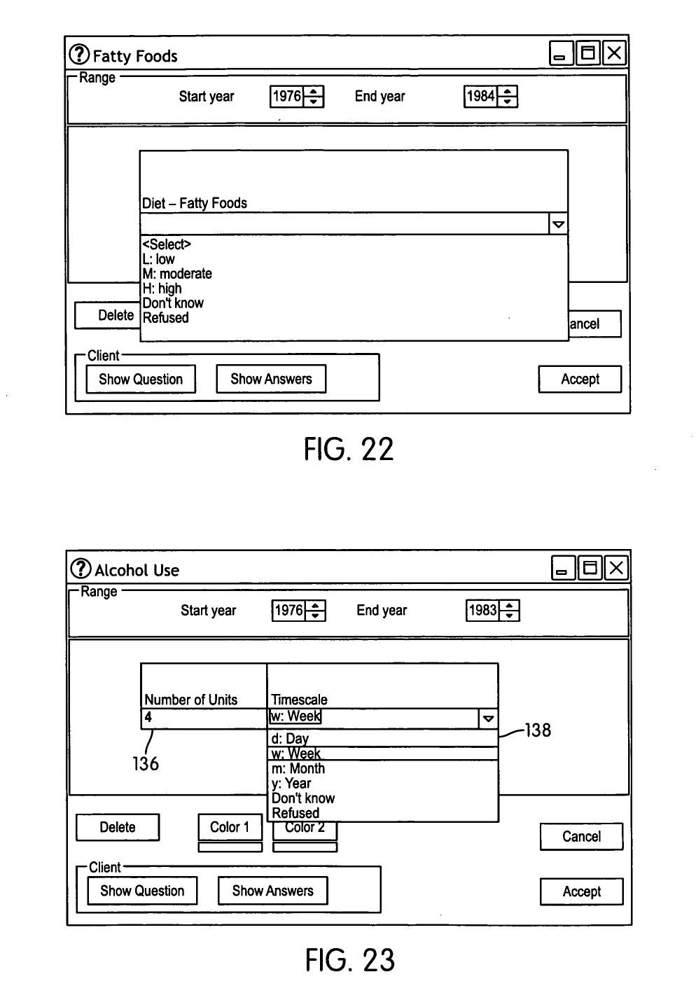

Health—Fatty Foods. As shown in FIG. 22, this timeline captures information about the amount of respondent's consumption of fatty foods at a given period. For example, a respondent may be asked to characterize their amount of fatty food consumption over a given period as low, moderate, high, or don't know, preferably with general definitions or guidelines given for each level to assist the respondent.

Health—Alcohol Use. This timeline captures information regarding the respondent's level of alcohol consumption for a given period. By moving the mouse cursor over the domain name, the information panel shows the detail of the question. The response window shown in FIG. 23 looks slightly different to the previous timeline response windows in this domain. This window captures data in the following way: If a respondent indicates that between the years 1976 and 1983 they consumed 4 alcoholic beverages (or alcoholic units) per week, then 4 is typed in the text entry box 136 under “number of units”. To indicate that the frequency of this response is per week, the drop-down menu 138 is used, and “week” is selected from the timescale drop-down list. The full list of options here is as follows: day, week, month, year, don't know, or refused. It may be desirable to provide on the interviewer and/or respondent screen a guide to quantities of alcohol that make up one alcoholic beverage, or unit, such as, an alcoholic beverage is measured as 30 ml of liquor, 150 ml of wine, or 240 ml of beer.

Both of these pieces of information are then passed into the timeline.

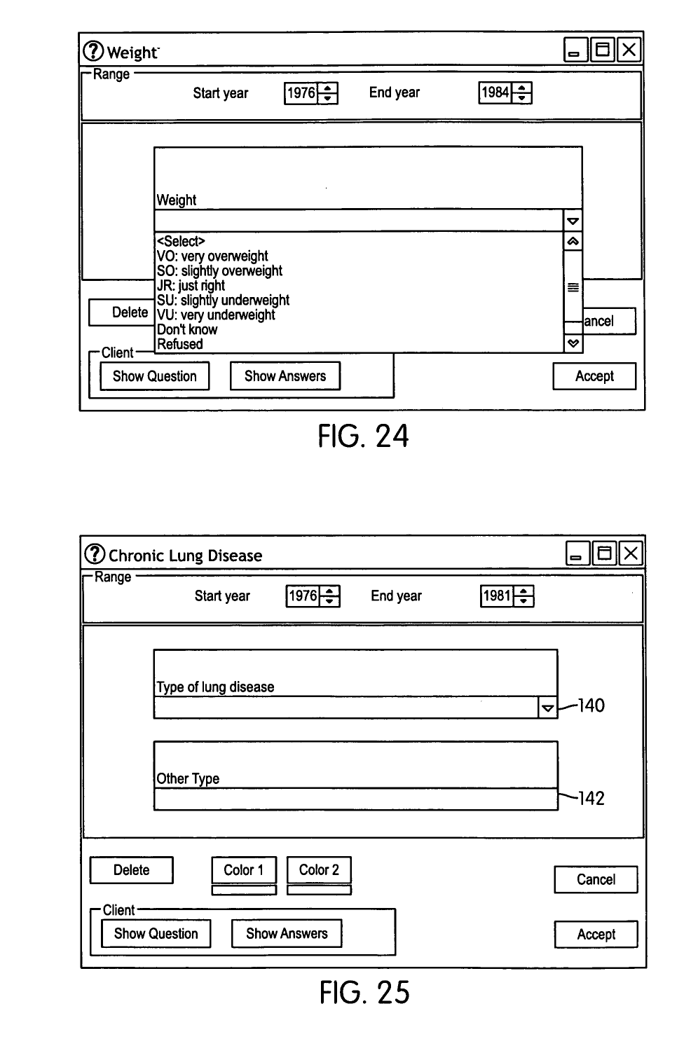

Health—Weight. As shown in FIG. 24, this timeline captures information about the respondent's weight at a given period. A representative list of possible options for this timeline is: very overweight, slightly overweight, just right, slightly underweight, very underweight, don't know or refused.

Medical History Domain

The Medical History domain features timelines for certain illnesses and conditions that the respondent may have been diagnosed as having at various times. Each condition the questionnaire is concerned with has been given its own timeline as described below:

Chronic Lung Disease. The response window for this timeline is shown in FIG. 25. This timeline captures whether the respondent has ever been diagnosed with a form of chronic lung disease. Preferably, the response window for this timeline not only provides a short list 140 of possible types of lung disease of interest, but also allows for entry of a custom-type of lung disease by selecting “other type of lung disease—please specify” from the drop-down list, and then using the text-entry box 142 to enter the details. A representative list of lung disease types (and lay terms for each disease) provided is as follows:
Chronic Bronchitis (inflammation of the lungs' airways)
Chronic Obstructive Lung Disease (lung disorder in which the flow of air in and out of the lungs is poor or impaired)
Asthma (breathing disorder in which there is wheezing and difficult breathing; a lung disease associated with tightening of the air passages)
Pneumonia (an infection involving the lungs)
Tuberculosis
Asbestosis (lung disease caused by inhaling asbestos)
Silicosis (lung disease caused by inhaling silica dust; also known as stone mason's disease)
Pneumoconiosis (lung disease caused by inhaling mineral or metallic particles such as coal dust; also known as miner's lung or black lung)
Collapsed Lung
Emphysema (a disorder in which too much air collects deep in the lungs; a destructive lung disease characterized by large damaged airspaces and poor air exchange)
Other Respiratory, Breathing Or Lung Disease—Please specify

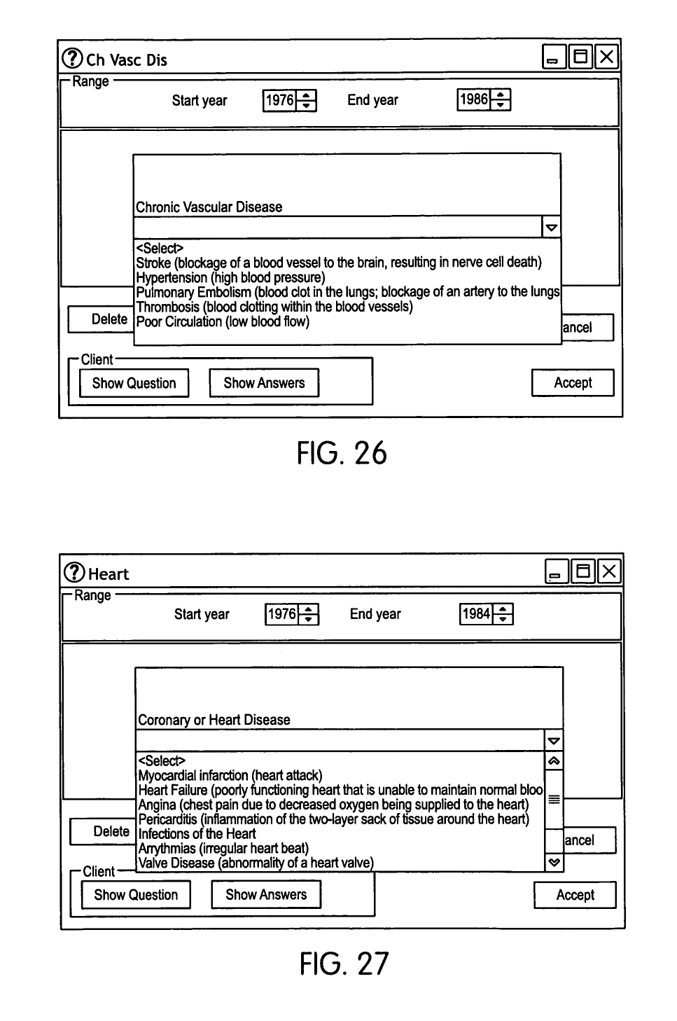

The next timeline is for chronic vascular disease, and the response window is shown in FIG. 26. It captures whether a respondent has been diagnosed as suffering from particular forms of chronic vascular disease at any given period. The data is captured through a drop-down list. A representative list of options presented by the drop-down list is as follows:
Stroke (blockage of a blood vessel to the brain, resulting in nerve cell death)
Hypertension (high blood pressure)
Pulmonary Embolism (blood clot in the lungs; blockage of an artery to the lungs by a clot or other material)
Thrombosis (blood clotting within the blood vessels)
Poor Circulation (low blood flow)

Coronary or Heart Disease. The response window for this timeline is shown in FIG. 27. This timeline captures whether a respondent has been diagnosed as having a form of coronary or heart disease at any point in time, through selecting the appropriate option from a drop-down list. A representative list of options which can be selected for this timeline is as follows:
Myocardial Infarction (heart attack)
Heart Failure (poorly functioning heart that is unable to maintain normal blood flow)
Angina (chest pain due to decreased oxygen being supplied to the heart)
Pericarditis (inflammation of the two-layer sack of tissue around the heart)
Infections of the Heart
Arrhythmias (irregular heart beat)
Valve Disease (abnormality of a heart valve)
Rheumatic Heart Disease (damage caused to the heart by rheumatic fever)
Congenital Heart Disease (heart disease present at birth)

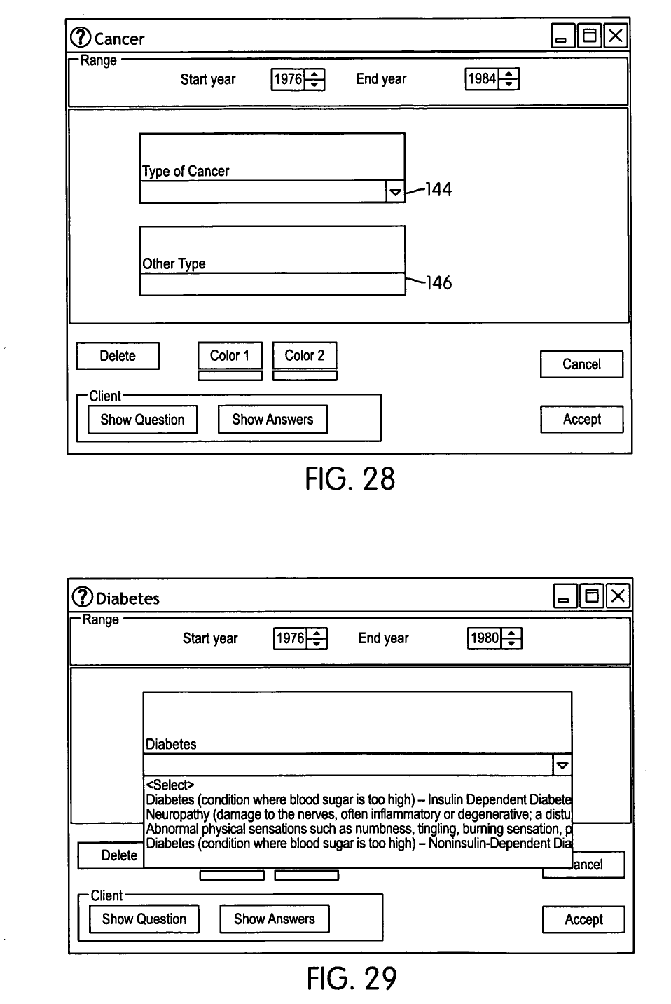

Cancer. The response window for this timeline is shown in FIG. 28. This timeline captures whether a respondent has been diagnosed as having a form of cancer at a given time. The response window for this timeline is similar to that for chronic lung disease, in so far as there is an optional text-entry box 146 for recording a type of cancer that may not be provided in the drop-down list 144. A representative list of possible entries for this drop-down list is as follows: lung, breast, colon, rectum, esophagus, stomach, pancreas, bladder, ovary, lymphoma, leukemia, brain, kidney, liver, head and neck, malignant melanoma, cervix, or other cancer—please specify.

Diabetes. The response window for this timeline is shown in FIG. 29. This timeline captures whether a respondent has been diagnosed with a particular type of diabetes, through selecting the appropriate option from a drop-down list. The following is a complete list of possible options:
Diabetes (condition in which blood sugar is too high)
   Insulin-Dependent Diabetes Mellitus (type 1 diabetes; a condition in which blood sugar can only be controlled by insulin therapy injection)
   Non-insulin-Dependent Diabetes Mellitus (type 2 diabetes; a condition in which blood sugar can be controlled by diet or drug therapy without needing insulin injection)
Neuropathy (damage to the nerves, often inflammatory or degenerative; a disturbance in the function of the brain or spinal chord that may affect the nerves and muscles)
Abnormal physical sensations such as numbness, tingling, and burning sensation, prickling or itching that were related to high blood sugar
   Tobacco History Domain

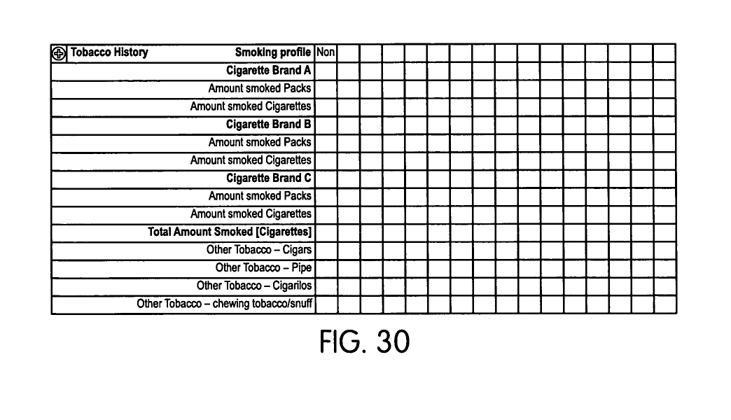

This domain asks the respondent to provide information regarding their smoking history. As shown in FIG. 30, through several timelines it will capture brand names and quantities smoked of cigarettes. It will also ask whether the respondent has smoked other tobacco products such as pipes or cigarillos.

In a preferred implementation, one question asks, “Have you ever smoked 100 or more cigarettes in your entire lifetime?” This is to determine if the respondent is a smoker or non-smoker. The responsive alternatives for this question are Yes, No, Don't Know and Refused. An appropriate response window (not shown) is provided for entering the response. A follow-up question asks, “Did you smoke 100 or more cigarettes between [a predefined time period, such as, two years from date of interview and following 12 months]?” This question is asked to determine if the respondent is a current smoker (within definition established in advance). The responsive alternatives for this question are also Yes, No, Don't Know and Refused. An appropriate response window (not shown) is provided for entering the response. Another question asks whether the respondent was a smoker or not over a given period, through a simple two-choice (i.e., yes/no) drop down list.

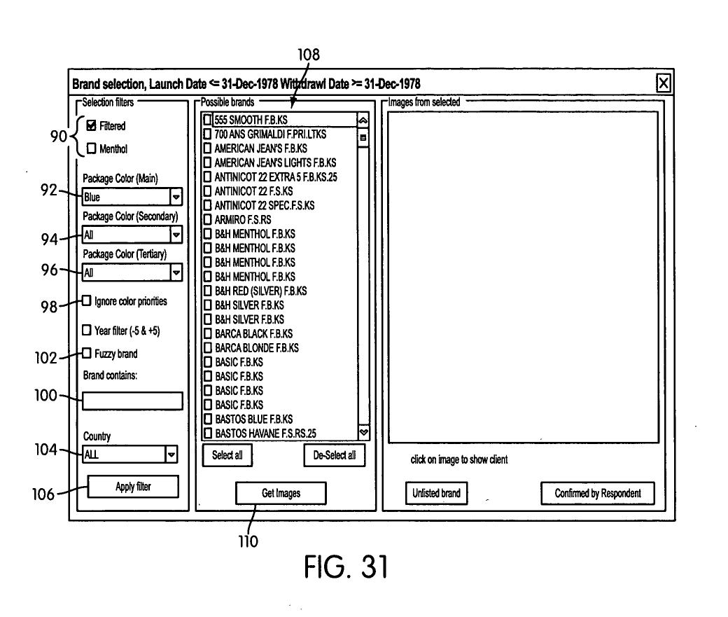

The next question to be completed is for identifying a cigarette brand the respondent smoked. By selecting a cell or cell-range, the computer-aided instrument will display the response window shown in FIG. 31. Here, the following steps should be followed to successfully ascertain and record the respondent's cigarette brand. Click in the appropriate box 90 to capture whether the brand was filtered and/or menthol. The respondent is asked to try and recall the main color or colors from the packet design of the cigarette brand the respondent used. The interviewer selects the appropriate color for main package color 92, and other colors 94,96 if appropriate. If prioritizing the colors (e.g. main color, secondary color) is not appropriate, the interviewer selects the ignore color priorities box 98. If the respondent can recall the brand name, or part of the brand name, the details remembered can be entered in the text box labeled “brand contains:” 100. If the respondent is unsure of the exact spelling, or can remember vague details of the spelling, the fuzzy search box 102 can be selected, which will broaden the search to include those brand names which include the consonants provided in any order. Finally, the country 104 of where the cigarettes were purchased can be selected from the drop-down list, or be marked as ALL for a far broader search. This will substantially increase the number of possible brands returned. Once this information has been recorded, press the apply filter button 106 in the bottom left-hand corner of the response window.

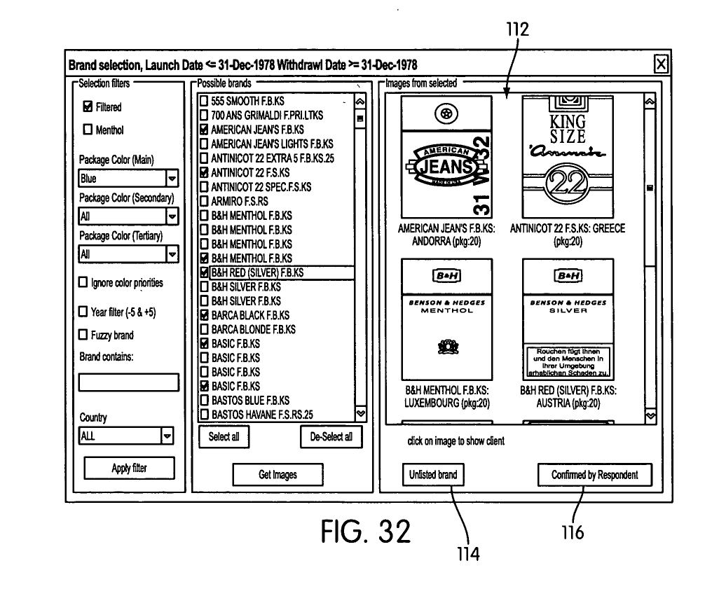

This brings up a range of possible brands in the middle section 108 of the window as shown in FIG. 31. Before the user selects the “apply filter” button, the middle section is blank. From this list, the interviewer identifies the brands which best fit the information the interviewer has received so far, and clicks the box next to each one of the brands. Next, the interviewer clicks the get images button 110 below the list, and the computer-aided instrument will display in the images area 112 the packets for the brands selected as shown in FIG. 32. To show the packet to the respondent, the interviewer clicks on an image, and the image appears on the respondent's screen. Although the images are black and white in FIG. 32, in a preferred embodiment, the images are in color and accurately portray the packaging of a particular cigarette brand. Also the brand packaging images reflect not only brands and styles but are also specific to country in which the cigarette was sold as well as the year sold. This is important because the tar content of a particular brand and style of cigarette may vary over time and depending on where the cigarette is sold.

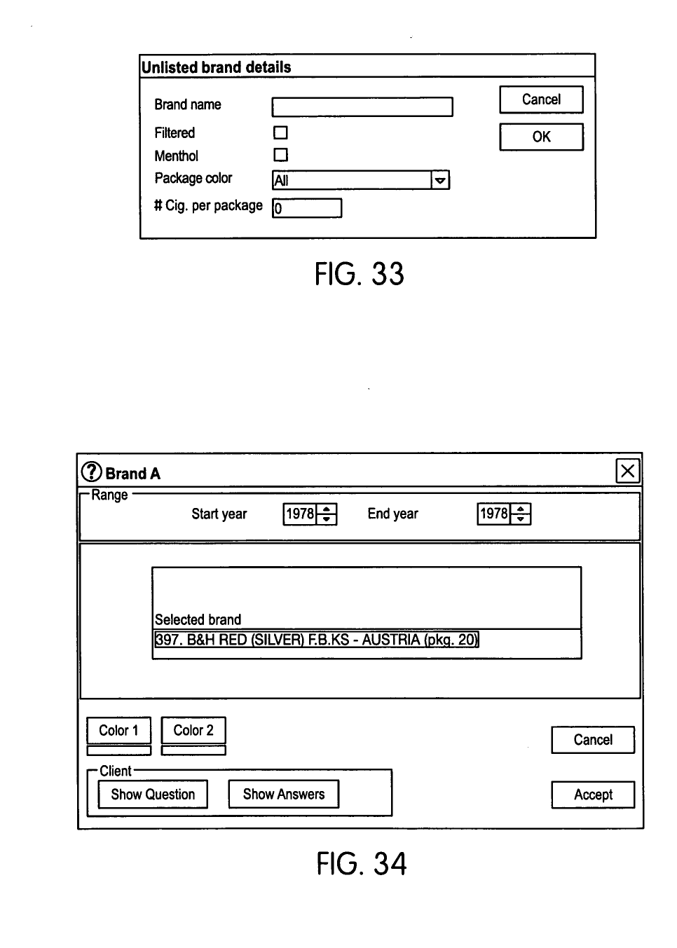

If the required brand cannot be identified, the unlisted brand button 114 can be pressed, to bring up a selection window (see FIG. 33) to capture whatever details can be recalled about the brand smoked. The details which will be asked for include the possible spelling of the brand name, the main color of the packet, the number of cigarettes in a packet, whether the cigarettes were filtered, and whether they were menthol cigarettes. The OK button can then be pressed, to display a response window (not shown), with the captured details already present.

Once the correct packet has been identified, the interviewer clicks on the “confirmed by respondent” button 116, and the window will close and be replaced by the response window shown in FIG. 34, with the selected brand name already included, along with other relevant details about the specific brand smoked.

The respondent should now be asked how many cigarettes of this particular brand he or she smoked. The response can be captured either as an amount in packets, or an amount in cigarettes. A timeline for each is provided, with a simple text entry box to enter the information. If the amount is entered in packets, the CAI automatically calculates the amount in cigarettes (if possible), and vice versa. The total cigarettes smoked timeline is updated on the interviewer's screen, but preferably remains concealed at all times on the respondent's screen.

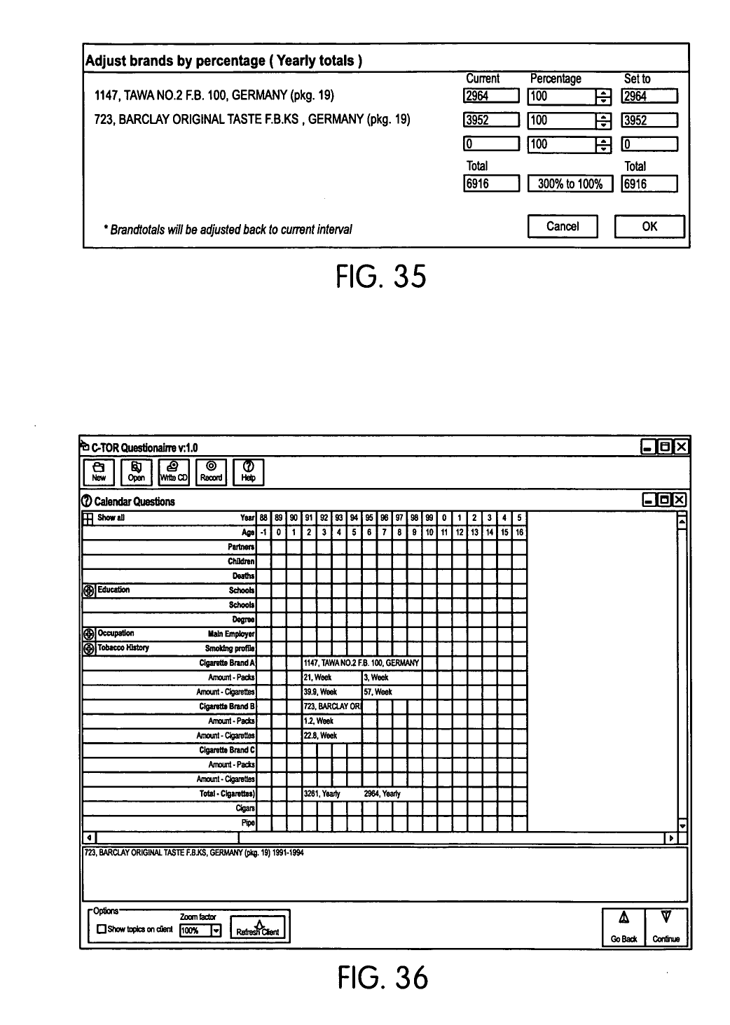

If a respondent indicates that more than one brand was smoked in a smoking interval, it may be that the two or more brands were not smoked at the same time, but were smoked when the other was not available. In this instance, the total cigarettes smoked timeline will display an inaccurate figure, as it will combine the totals smoked for the brands entered. The interviewer can click on the total cigarettes smoked timeline and call up a screen whereby approximate percentages can be entered as to how the number of cigarettes for each brand was split. (See FIG. 35)

Once all the requested information has been entered, the total cigarettes smoked timeline is updated (see FIG. 36), as are the corresponding timelines for amount in packs and amount in cigarettes for the brand(s) concerned. The system preferably accommodates timelines to capture brand and quantity information for up to 3 different brands at any one time.

The computer-aided instrument then instructs the interviewer to ask about other forms of tobacco that the respondent may have used, such as cigars, pipes, cigarillos, snuff, or chewing tobacco. Response windows preferably record yes or no responses as to whether the respondent used these products during any given period.

Those of ordinary skill in the art will readily appreciate that the forgoing methodology can be applied to obtain retrospective autobiographical data on use of a variety of consumer products and/or exposure to substances, whereby a respondent can be assisted in recalling the source or sources of (e.g., the particular brand name (i.e., entity which manufactured and/or marketed and sold)) the product(s) used by the respondent at various times by showing the respondent images of source-identifying features (e.g., advertising, commercial packaging, company logos and trademarks, product appearance, trade dress features of the products themselves, etc.) associated with the various sources of the relevant products at the relevant time(s).

Occupation Domain

The domain aims to capture information about the working life of the respondent. It comprises several timelines: employer name, industry type, and others smoking in the workplace. Employer name captures the name of the company the respondent worked for in a particular employment interval with a text entry box. Industry type is for capturing the industry the respondent worked in and the relevant year range. For example, a respondent may have had two occupations while working at a particular company, resulting in a series of timelines showing one occupation for part of the time the respondent worked for a particular employer and another occupation for a different part of the time the respondent worked for that employer.

The response window for industry type (not shown) provides a space for specifying start and end years for defining a time range and a large drop-down list from which to select an industry as follows: pesticide production or application, roofer or asphalt worker, beryllium refining, coke plant, painter, asbestos production, welder, gas worker, construction industry, arsenic mining, iron ore mining, zinc-lead mining, asbestos mining, talc mining, gold mining, uranium mining, other mining, hauler or truck/bus driver, garage/service station, production of chloromethylether, printing industry, rubber industry, production of chromate pigments, leather industry, production of batteries, cadmium smelting, copper smelting, laundry or dry cleaning, chromium plating, ferrochromium production, man-Made mineral fibers industry: glasswool, rockwool, continuous filament or other, iron or steel foundry, production of aluminum, butcher, nickel refining, chimney sweep, production of mustard gas, don't know, or refused.

The remaining timeline in the occupation domain is “others smoking” and captures the frequency with which a respondent was exposed to work colleagues smoking in the workplace. This information is captured through a response window (not shown) which includes spaces for specifying start and end years for defining a time range and a drop-down list of frequency options as follows:
worked outdoors
daily
several times a week
once a week
several times a month
once a month
less than once a month
not at all
don't know
refused
   Socio-Economic Domain

The preferred embodiment of the present invention includes one final domain of questions, the socioeconomic domain. This domain, however, does not follow the calendar question structure. Instead, it presents a series of multiple choice questions, with each question having a range of possible answers available for selection. A slightly different version of this domain is used if the respondent did not score high enough in the cognitive capacity questions, in order to capture if the respondent's marital status, smoking history, and educational attainment.

This domain features several questions, grouped into sections that help to confirm some of the data captured earlier in the questionnaire and to assess the respondent's relative socio-economic status. A representative list of the questions with their answer sets follows:

One question is concerned with income and asks if any current household members have an income of their own. The possible answers are: yes, no, refused, or don't know.

Another question asks the respondent to characterize their current household's monthly net income. The possible answers are: 0-1000 euro (or equivalent in dollars or other currency), 1001-1500 euro (or equivalent in dollars or other currency), 1501-2000 euro (or equivalent in dollars or other currency), 2001-3000 euro (or equivalent in dollars or other currency), 3001-4000 euro (or equivalent in dollars or other currency), 4001-5000 euro (or equivalent in dollars or other currency), 5001+ euro (or equivalent in dollars or other currency), refused, or don't know.

Another question asks how the respondent views their self-perceived quality of life. The possible answers are: living comfortably on present income, coping on present income, finding it difficult on present income, finding it very difficult on present income, don't know, or refused.

Another group of questions asks for information from the respondent about employment. One of these questions asks the respondent to pick a category that applies to their employment status within the last five years. The possible answers are: employed full-time, employed part-time, temporarily out of work, helping family member, not in labor force, unemployed, student/in school/in vocational training, retired, homemaker/home duties, permanently disabled, refused, or don't know. Another of these questions asks the respondent if they have ever supervised the work of other employees. The possible answers are: yes, no, refused, or don't know.

Another set of questions asks similar employment-related questions regarding other members of the household. One of these questions asks which member of the respondent's household has been the main source of household income within the last five years. The possible answers are: respondent, partner/spouse, respondent and partner/spouse about equal, other member(s) of household, refused, or don't know. Another of these questions asks the respondent to select a category that best fits the employment status of their most recent/current spouse/partner. The possible answers are: employed full-time, employed part-time, temporarily out of work, helping family member, not in labor force, unemployed, student/in school/in vocational training, retired, homemaker/home duties, permanently disabled, refused, or don't know. Another of these questions asks if the respondent's most recent/current spouse/partner has ever supervised the work of other employees. The possible answers are: yes, no, refused, or don't know.

Another set of questions asks about education. A series of these questions asks the respondent what is the highest level of education that their current/most recent spouse/partner, their father, and their mother completed. The possible answers are:
did not complete primary (compulsory) education
primary education or first stage of basic education
lower secondary education or second stage of basic education
upper secondary education
post-secondary, non-tertiary education
first stage of tertiary education (not leading directly to an advanced diploma)
second stage of tertiary education (leading directly to an advanced diploma)
don't know
refused
   (Note that the appropriate schooling types will be automatically displayed based on the country of residence that the respondent has indicated in the Introductory questions section. The customized response alternatives have been standardized based on the International Standard Classification of Education (ISCED)).

Once all the questions have been answered, the interviewer presses the CONTINUE button located at the bottom right-hand corner of the window. This will close down the question screens, and save the information captured by the questionnaire onto a CD or other (preferably portable) storage medium.

The CAI facilitates implementation of the present invention by providing efficient means for (1) storing electronic images of source identifying features, (2) indexing and searching through such stored images, and (3) retrieving and displaying images to a respondent to assist in consumer product source recall. The present invention is not, however, limited to a computerized implementation. The EHC questionnaire can, for example, be administered in a paper and pencil format, typically with the interviewer reading questions and instructions from a printed document and manually transcribing responses on a sheet of paper, preferably a pre-printed form. Source identifying features of relevant consumer products can be displayed to the respondent by showing printed drawings or photographs or showing physical samples of relevant consumer products, with products from different sources having different unique features. For example, collecting data regarding the use of particular pharmaceuticals may involve displaying various samples (e.g., pills or capsules) having unique, source identifying sizes, shapes, colors, etc.

Moreover, unique source identifying features are not necessarily limited to those features that are visible to the respondent, but may include any unique feature that can be perceived by the respondent, including sounds, odors, tastes, weights, and textures. For example, another application of the present invention may be in the collection of data concerning exposures to particular chemicals found in certain chemical fertilizers. Where fertilizers from different sources present unique perceptible characteristics (such as, color(s), texture, weight density, granularity, odor, etc.), the respondent may be assisted in recalling the particular fertilizers to which the respondent was exposed—even if the respondent did not see the fertilizer packaging and thus would not have been aware of the brand-name of the fertilizer—by presenting to the respondent samples of fertilizers originating from different sources.

While the invention has been described in connection with what are presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

1. A computer-implemented method of collecting retrospective, autobiographical data from a respondent utilizing a computer aided interviewing system comprising a data storage system, a processor system, an interviewer display system, an interviewer input system, and a respondent display system, the method comprising:
storing question data in the data storage system;
retrieving selected question data from the data storage system with the processor system;
the processor system using the retrieved question data to generate at the interviewer display system prompts to be used by an interviewer for eliciting from the respondent information concerning one or more aspects of the respondent's life for a predefined period of the respondent's life, including consumer product use or substance exposure over at least a portion of the predefined period;
storing in the data storage system source-identifying feature data from a plurality of sources of relevant consumer products or substances;
retrieving selected source-identifying feature data from the data storage system with the processor system; and
the processor system using the retrieved source-identifying feature data to generate at the respondent display system displays of source-identifying features corresponding to different sources of relevant consumer products or substances to assist the respondent in recalling the source or sources of the consumer product the respondent used or substance the respondent was exposed to at various times during the predefined period.

2. The method of claim 1, further comprising the processor system receiving the elicited information from the interviewer input system, storing the elicited information in the data storage system, and using the elicited information to generate at the interviewer display system a timeline including the predefined period to construct a visual reference of the elicited information.

3. The method of claim 1, wherein retrieving selected source-identifying feature data comprises:
entering with the interviewer input system one or more characteristics of a consumer product used by the respondent; and
the processor system using the one or more characteristics to locate in the data storage system one or more consumer products for which the one or more characteristics are applicable and retrieving the source-identifying feature data corresponding to the located consumer products.

4. The method of claim 3, wherein the one or more characteristics include one or more characteristics selected from the group comprising:
the country in which the respondent obtained the consumer product; and
one or more colors of the packaging of the consumer product that was used by the respondent.

5. The method of claim 1, wherein the source -identifying features include one or more features selected from the group comprising advertising, commercial packaging, company logos and trademarks, product appearance, or trade dress features associated with the various sources of the relevant consumer products or substances at the relevant time.

6. The method of claim 5, wherein the consumer products include cigarettes and the source-identifying feature comprises cigarette packages.

7. A method of collecting retrospective autobiographical data from a respondent, comprising:
eliciting from the respondent information concerning one or more aspects of the respondent's life for a predefined period of the respondent's life; and
entering the elicited information into a timeline including the predefined period to construct a visual reference of the elicited information,
wherein the aspects of the respondent's life include consumer product use or substance exposure over at least a portion of the predefined period, and the eliciting step comprises displaying to the respondent source-identifying features corresponding to different sources of relevant consumer products or substances to assist the respondent in recalling the source or sources of the consumer product the respondent used or substances the respondent was exposed to at various times during the predefined period.

8. The method of claim 7, wherein the source-identifying features include one or more features selected from the group comprising advertising, commercial packaging, company logos and trademarks, product appearance, trade dress features, sounds, odors, tastes, weights, and textures associated with the various sources of the relevant consumer products or substances at the relevant time.

9. The method of claim 8, wherein the relevant consumer products include cigarettes and the source-identifying feature comprises cigarette packages.

10. The method of claim 7, wherein aspects of the respondent's life further include the amount of the consumer product used by the respondent at various times during the predefined period.

11. The method of claim 7, wherein the aspects of the respondent's life further include one or more aspects selected from the group comprising: residence, marriages, marriage partners, non-spousal partners, children, deaths of significant persons, persons in dwelling or household, number of smokers in household, education, educational level achieved, diet, alcohol use, medical history, occupations, and socioeconomic condition.

12. The method of claim 7, further comprising administering a series of questions to assess the cognitive capacity of the respondent.

13. The method of claim 12, wherein the series of questions assessing the cognitive capacity of the respondent are administered prior to the eliciting step.

14. The method of claim 7, wherein said method is performed utilizing a computer aided interviewing system comprising a data storage system, a processor system, an interviewer display system, an interviewer input system, and a respondent display system, and wherein:
said eliciting step comprises:
the processor system retrieving selected stored question data from the data storage system with the processor system, and the processor system using the retrieved question data to generate at the interviewer display system prompts to be used by an interviewer for eliciting from the respondent the information concerning one or more aspects of the respondent's life for a predefined period of the respondent's life; and
the processor system retrieving selected stored source-identifying feature data from the data storage system, and the processor system using the retrieved source-identifying feature data to generate at the respondent display system displays of the source-identifying features; and
said entering step comprises utilizing the interviewer input system to input the elicited information into the processor system, which then stores the elicited in information in the storage system.

15. An article comprising a computer readable medium having software stored thereon including instructions for causing a computer aided interviewing system, including a data storage system, a processor system, an interviewer display system, an interviewer input system, and a respondent display system, to perform a series of steps comprising:
retrieve selected question data from the data storage system with the processor system;
the processor system generating at the interviewer display system, and using the retrieved question data, prompts to be used by an interviewer for eliciting from the respondent information concerning one or more aspects of the respondent's life for a predefined period of the respondent's life, including consumer product use or substance exposure over at least a portion of the predefined period;
retrieving selected source-identifying feature data from the data storage system with the processor system; and
the processor system generating at the respondent display system, and using the retrieved source-identifying feature data, displays of source-identifying features corresponding to different sources of relevant consumer products or substances to assist the respondent in recalling the source or sources of the consumer product the respondent used or substances the respondent was exposed to at various times during the predefined period.

16. The article of claim 15, said series of steps further comprising the processor system receiving the elicited information from the interviewer input system, storing the elicited information in the data storage system, and using the elicited information to generate at the interviewer display system a timeline including the predefined period to construct a visual reference of the elicited information.

17. The article of claim 15, wherein retrieving selected source-identifying feature data comprises:
enabling a user to enter with the interviewer input system one or more characteristics of a consumer product used by the respondent; and
the processor system using the one or more characteristics to locate in the data storage system one or more consumer products for which the one or more characteristics are applicable and retrieving the source-identifying feature data corresponding to the located consumer products.

18. The article of claim 17, wherein the one or more characteristics include one or more characteristics selected from the group comprising:
the country in which the respondent obtained the consumer product; and
one or more colors of the packaging of the consumer product that was used by the respondent.

19. The article of claim 15, wherein the source-identifying features include one or more features selected from the group comprising advertising, commercial packaging, company logos and trademarks, product appearance, or trade dress features associated with the various sources of the relevant consumer products or substances at the relevant time.

20. The article of claim 19, wherein the consumer products include cigarettes and the source-identifying feature comprises cigarette packages.

21. A computer-aided interviewing system for facilitating the collection of retrospective autobiographical data from a respondent, comprising:
a data storage system storing question data and source-identifying feature data;
a processor system for retrieving data from said data storage system, said processor system being constructed and arranged to:
retrieve question storage data from said data storage system and generate displayable prompts, the prompts to be used by an interviewer for eliciting from a respondent information concerning one or more aspects of the respondent's life for a predefined period of the respondent's life, including consumer product use or substance exposure over at least a portion of the predefined period; and
retrieve source-identifying feature data from said data storage system and generate displays of source-identifying features corresponding to different sources of relevant consumer products or substances to assist the respondent in recalling the source or sources of the consumer product the respondent used or substance the respondent was exposed to at various times during the predefined period;
an interviewer display system in communication with said processor system and constructed and arranged to display to an interviewer said prompts generated by said processor system; and
a respondent display system in communication with said processor system and constructed and arranged to display to a respondent said displays of source-identifying features generated by said processor system.

22. The computer-aided interviewing system of claim 21, said data storage system further storing respondent response data, and said computer-aided interviewing system further comprising an interviewer input system in communication with said processor system and constructed and arranged to enable the interviewer to input information elicited from said the respondent.

23. The computer-aided interviewing system of claim 21, wherein said interviewer display system and said respondent display system comprise separate systems in communication with said processor system and constructed and arranged to present separate displays to each of the interviewer and the respondent, respectively.
